(19) United States
(12) Patent Application Publication
(10) Pub. No.: US 2006/0135157 A1
(43) Pub. Date: Jun. 22, 2006

(54) Network interworking system and method for providing seamless voice service and short message service between wireless communication networks, and packet switch apparatus therefor

(75) Inventors: Hye-Won Baek, Seongnam-si (KR); Dae-Seok Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/263,861

(22) Filed: Nov. 2, 2005

(30) Foreign Application Priority Data
Nov. 2, 2004 (KR) 2004-88318
Nov. 22, 2004 (KR) 2004-95821

(51) Int. Cl. H04Q 7/20

(52) U.S. Cl. 455/433; 455/435.1

(57) ABSTRACT

A network interworking system is provided for connecting a voice call between a mobile terminal in a wireless packet network that provides VoIP service and a mobile terminal in a mobile communication network that provides circuit-switched service. A home location register (HLR) registers therein location information of terminals and a subscriber profile. A packet switch or a mobile switching center (MSC), in which a calling terminal is located, transmits a call connection request to a location of a called terminal, detected through the HLR, upon receiving an origination message including a terminal identifier of the called terminal. An MSC or a packet switch, in which the called terminal is located, transmits a message for voice call connection to the called terminal upon receiving the call connection request for the called terminal.

### CROSS-REFERENCE TO RELATED APPLICATIONS

This application claims the benefit under 35 U.S.C. §119(a) of Korean Patent Application No. 10-2004-0088318 entitled “Network Interworking System And Method For Providing Seamless Voice Service And Short Message Service Between Wireless Communication Networks, And Packet Switch Apparatus Therefor” filed in the Korean Intellectual Property Office on Nov. 2, 2004, and Korean Patent Application No. 10-2004-0095821 entitled “Network Interworking System And Method For Providing Seamless Voice Service And Short Message Service Between Wireless Communication Networks, And Packet Switch Apparatus Therefor” filed in the Korean Intellectual Property Office on Nov. 22, 2004, the entire disclosures of both of which are hereby incorporated by reference.

### BACKGROUND OF THE INVENTION

1 Field of the Invention

The present invention relates generally to a network interworking system and method for providing wireless communication service between heterogeneous/homogeneous networks and a switching apparatus therefor. In particular, the present invention relates to a network interworking system and method for providing seamless voice service and short message service (SMS) between heterogeneous/homogeneous networks, and a packet switch apparatus therefor.

2 Description of the Related Art

Mobile communication networks providing conventional circuit-switched voice service are classified into Frequency Division Multiple Access (FDMA) networks, Time Division Multiple Access (TDMA) networks, and Code Division Multiple Access (CDMA) networks according to their communication methods. In an FDMA network, a predetermined frequency band is divided into a plurality of frequency channels and the frequency channels are individually allocated to every subscriber. In a TDMA network, one frequency channel is time-shared by a plurality of subscribers. In a CDMA network, a plurality of subscribers use the same frequency band in the same time band and every subscriber is allocated its own unique code.

With the rapid progress of communication technologies, mobile communication networks have risen to the level of providing high-speed data service in which subscribers can enjoy not only general voice service, but also multimedia service such as e-mail, still image and moving image services, using a mobile terminal. As is well known to those skilled in the art, 3^{rd} generation (3G) mobile communication systems supporting both voice service and packet service are generally classified into synchronous CDMA2000 1x systems and asynchronous Universal Mobile Telecommunication System (UMTS) systems.

Existing voice service is provided through a circuit switched network such as a public switched telephone network (PSTN), and the above-described mobile communication networks also provide circuit-switched voice service. Packet service has been provided through an Internet Protocol (IP) network such as the Internet. Recently, however, Voice over Internet Protocol (VoIP), which is a well-known technology, has been proposed to provide voice service even through the IP network. The number of VoIP users is rapidly increasing due to the advantages that, as the IP network such as the Internet has developed and the 56-Kbps voice bandwidth limit of the circuit switched network has been overcome, it enables a high-quality voice call and allows subscribers to make an inexpensive international call with only an Internet fee. In addition, it can provide various application solutions and additional services.

Conventionally, VoIP service was provided only through wire networks to which a personal computer could be connected. Recently, however, active research is being conducted to provide VoIP service based on a Session Initiation Protocol (SIP) even through wireless packet networks such as a Wireless Local Area Network (WLAN) and a Wireless Broadband Internet (WiBro) for providing portable Internet service using a frequency of 2.3 GHz.

In addition, research is being carried out on a so-called dual-mode terminal that is capable of accessing both the mobile communication network and the wireless packet network. However, both the general mobile communication network-based voice service provided through a mobile switching center (MSC) and VoIP-based voice service provided through the wireless packet network are provided only through their authorized networks, and the foregoing research has failed to provide a network interworking scheme for allowing a subscriber to receive a call originated from the mobile communication network in the wireless packet network, or allowing the subscriber to receive a call originated from the wireless packet network in the mobile communication network, thereby making it difficult to provide seamless voice service to the service subscriber. Accordingly, a need exists for a system and method for providing seamless voice service to the service subscriber.

The existing Short Message Service (SMS) is provided through the circuit-switched mobile communication network. Recently, although active research is being conducted on the wireless packet network such as the WLAN and the WiBro for providing portable Internet service using a frequency of 2.3 GHz, the research has failed to propose a scheme for providing the SMS service used in the mobile communication network through the wireless packet network. Even though an SMS message of a subscriber is preferably transmitted to a called terminal using the general packet service, it is difficult to provide retransmission service like the SMS service used in the mobile communication network when the called terminal cannot receive a call due to, for example, its power being off.

Even though it is assumed for illustration purposes that SMS service is possible in the wireless packet network, because the SMS service in the mobile communication network and the SMS service in the wireless packet network are provided through heterogeneous networks, it is difficult to receive an SMS message originated from the mobile communication network in the wireless packet network, or to receive an SMS message originated from the wireless packet network in the mobile communication network. Therefore, in the wireless communication system in which the mobile communication network and the wireless packet network coexist, it is hard to provide stable SMS service to the service subscribers.

Accordingly, a need exists for a system and method for providing seamless voice service between a general mobile communication network and a wireless packet network.

### SUMMARY OF THE INVENTION

It is, therefore, an object of embodiments of the present invention to substantially solve the above and other problems, and to provide a network interworking system and method for providing seamless voice service between a general mobile communication network and a wireless packet network.

It is another object of embodiments of the present invention to provide a network interworking system and method for receiving a call originated from a general mobile communication network in a wireless packet network, and for receiving a call originated from the wireless packet network in the general mobile communication network.

It is yet another object of embodiments of the present invention to provide a packet switch apparatus for a wireless packet network for interworking voice service between a general mobile communication network and a wireless packet network.

It is yet another object of embodiments of the present invention to provide a network interworking system and method for providing seamless voice service between wireless packet networks.

It is still another object of embodiments of the present invention to provide a system and method for registering/deregistering a location of a mobile terminal in a wireless packet network interworking with a mobile communication network.

It is still another object of embodiments of the present invention to provide a network interworking system and method for providing seamless SMS service between a general mobile communication network and a wireless packet network.

It is still another object of embodiments of the present invention to provide a network interworking system and method for receiving an SMS message originated from a general mobile communication network in a wireless packet network, and receiving an SMS message originated from the wireless packet network in the mobile communication network.

It is still another object of embodiments of the present invention to provide a packet switch apparatus for a wireless packet network for interworking SMS service between a mobile communication network and a wireless packet network.

It is still another object of embodiments of the present invention to provide a network interworking system and method for providing SMS service between wireless packet networks belonging to different domains.

According to one aspect of the present invention, a network interworking system is provided for connecting a voice call from a calling terminal in a wireless packet network that provides voice over Internet protocol (VoIP) service to a called terminal in a mobile communication network that provides circuit-switched voice service. The system comprises a home location register (HLR) for registering therein location information of terminals and a subscriber profile, a packet switch for transmitting a call connection request to a location of the called terminal, detected through the HLR, upon receiving an origination message including a terminal identifier of the called terminal, an access network for receiving the origination message from the calling terminal in the wireless packet network and delivering the received origination message to the packet switch, a mobile switching center (MSC) for transmitting a paging message for voice call connection to the called terminal upon receiving a call connection request for the called terminal from the packet switch, and a base station system (BSS) for transmitting a paging message from the MSC in the mobile communication network to the called terminal.

According to another aspect of the present invention, a network interworking system is provided for connecting a voice call from a calling terminal in a mobile communication network that provides circuit-switched voice service to a called terminal in a wireless packet network that provides voice over Internet protocol (VoIP) service. The system comprises a home location register (HLR) for registering therein location information of terminals and a subscriber profile, a mobile switching center (MSC) for transmitting a call connection request to a location of the called terminal, detected through the HLR, upon receiving an origination message including a terminal identifier of the called terminal, a base station system (BSS) for receiving the origination message from the calling terminal in the mobile communication network and delivering the origination message to the MSC, a packet switch for transmitting a request message for voice call connection to the called terminal upon receiving a call connection request for the called terminal from the MSC, and an access network for receiving the request message from the packet switch in the wireless packet network and delivering the request message to the called terminal.

According to yet another aspect of the present invention, a network interworking method is provided for connecting a voice call from a calling terminal in a wireless packet network that provides voice over Internet protocol (VoIP) service to a called terminal in a mobile communication network that provides circuit-switched voice service. The method comprises the steps of registering location information of terminals and a subscriber profile in a home location register (HLR), transmitting an origination message including a terminal identifier of the called terminal to a packet switch in the wireless packet network, transmitting, by the packet switch, a call connection request to a location of the called terminal, detected through the HLR based on the terminal identifier, upon receiving the origination message, and upon receiving the call connection request for the called terminal, transmitting a paging message for voice call connection to the called terminal by a mobile switching center (MSC) in the mobile communication network.

According to yet another aspect of the present invention, a network interworking method is provided for connecting a voice call from a calling terminal in a mobile communication network that provides circuit-switched voice service to a called terminal in a wireless packet network that provides voice over Internet protocol (VoIP) service. The method comprises the steps of registering location information of terminals and a subscriber profile in a home location register (HLR), transmitting an origination message including a terminal identifier of the called terminal to a mobile switching center (MSC) in the mobile communication network, transmitting a call connection request to a location of the called terminal, detected through the HLR based on the terminal identifier, and upon receiving the call connection request for the called terminal, transmitting a request message for voice call connection to the called terminal by the packet switch in the wireless packet network.

According to still another aspect of the present invention, a network interworking system is provided for connecting a voice call from a calling terminal in a first wireless packet network that provides voice over Internet protocol (VoIP) service to a called terminal in a second wireless packet network that provides circuit-switched voice service. The system comprises a home location register (HLR) for registering therein location information of terminals and a subscriber profile, a first packet switch in the first wireless packet network for transmitting a call connection request to a location of the called terminal, detected through the HLR, upon receiving an origination message including a terminal identifier of the called terminal, a first access network for receiving the origination message from the calling terminal and delivering the received origination message to the first packet switch, a second packet switch in the second wireless packet network for transmitting a request message for voice call connection to the called terminal upon receiving a call connection request for the called terminal from the first packet switch, and a second access network for transmitting the request message from the second packet switch to the called terminal.

According to still another aspect of the present invention, a packet switch apparatus included in a network interworking system is provided for connecting a voice call between a first mobile terminal in a wireless packet network that provides voice over Internet protocol (VoIP) service and a second mobile terminal in a mobile communication network that provides circuit-switched voice service. The apparatus comprises a softswitch system comprising a session initiation protocol (SIP) message handler for performing location registration on the first mobile terminal through a home location register (HLR) shared with a mobile switching center (MSC) in the mobile communication network and transmitting/receiving a SIP-based message for voice call connection between the first and second mobile terminals, and an MSC interworking unit for exchanging a message including call setup information between the first and second mobile terminals with the MSC, and a gateway connected to the softswitch system through a predetermined control protocol for performing data conversion between the wireless packet network and the mobile communication network.

According to still another aspect of the present invention, a location registration method is provided for a mobile terminal in a network interworking system including a packet switch. The method comprises the steps of transmitting, by the mobile terminal, a session initiation protocol (SIP) registration request message including its own terminal identifier and electronic serial number (ESN) to the packet switch, transmitting, by the packet switch, a location registration request message including the terminal identifier and the ESN to a home location register (HLR) shared by a mobile communication network and a wireless packet network, determining by the HLR whether the mobile terminal is a registered terminal by analyzing the terminal identifier and the ESN, and transmitting a location registration response message including the corresponding subscriber profile to the packet switch if the mobile terminal is a registered terminal, and registering, by packet switch, a location of the mobile terminal in a visitor location register (VLR) based on the subscriber profile.

According to still another aspect of the present invention, a network interworking system is provided for providing short message service (SMS) service from a calling terminal in a wireless packet network to a called terminal in a circuit-switched mobile communication network. The system comprises a home location register (HLR) for registering therein location information of terminals and a subscriber profile, a packet switch for, if an SMS message and an origination message including a terminal identifier of the called terminal are received from the calling terminal, transmitting a first delivery message including the SMS message and the terminal identifier, an SMS center (SMSC) for, upon receiving the first delivery message, transmitting a second delivery message including the SMS message and the terminal identifier to a location of the called terminal, detected through the HLR, and a mobile switching center (MSC) for, upon receiving the second delivery message, transmitting a paging message indicating arrival of the SMS message to the called terminal.

According to still another aspect of the present invention, a network interworking system is provided for providing short message service (SMS) service from a calling terminal in a circuit-switched mobile communication network to a called terminal in a wireless packet network. The system comprises a home location register (HLR) for registering therein location information of terminals and a subscriber profile, a mobile switching center (MSC) for, if an SMS message and an origination message including a terminal identifier of the called terminal are received from the calling terminal, transmitting a first delivery message including the SMS message and the terminal identifier, an SMS center (SMSC) for, upon receiving the first delivery message, transmitting a second delivery message including the SMS message and the terminal identifier to a location of the called terminal detected through the HLR, and a packet switch for, upon receiving the second delivery message, transmitting a request message indicating arrival of the SMS message to the called terminal.

According to still another aspect of the present invention, a network interworking system is provided for providing short message service (SMS) service from a calling terminal in a first wireless packet network to a called terminal in a second wireless packet network. The system comprises a home location register (HLR) for registering therein location information of terminals and a subscriber profile, a first packet switch for, if an SMS message and an origination message including a terminal identifier of the called terminal are received from the calling terminal, transmitting a first delivery message including the SMS message and the terminal identifier, an SMS center (SMSC) for, upon receiving the first delivery message, transmitting a second delivery message including the SMS message and the terminal identifier to a location of the called terminal detected through the HLR, and a second packet switch for, upon receiving the second delivery message from the SMSC, transmitting a request message indicating arrival of the SMS message to the called terminal.

According to still another aspect of the present invention, a packet switch apparatus is provided in a network interworking system for providing short message service (SMS) service between a first mobile terminal in a wireless packet network and a second mobile terminal in a circuit-switched mobile communication network. The apparatus comprises a softswitch system including a session initiation protocol (SIP) message handler for performing location registration on the first mobile terminal through a home location register (HLR) shared with a mobile switching center (MSC) in the mobile communication network and transmitting/receiving a SIP-based message for SMS message delivery between the first and second mobile terminals, and an SMS center (SMSC) interworking unit for exchanging a delivery message including an SMS message and a terminal identifier of the called terminal with the SMSC, and a gateway connected to the softswitch system through a predetermined control protocol for performing data conversion between the wireless packet network and the mobile communication network.

### BRIEF DESCRIPTION OF THE DRAWINGS

The above and other objects, features and advantages of the present invention will become more apparent from the following detailed description when taken in conjunction with the accompanying drawings, in which:

FIG. 1 is a block diagram illustrating a configuration of a network interworking system between heterogeneous networks according to an embodiment of the present invention;

FIG. 2 is a block diagram illustrating a structure of a packet switch according to an embodiment of the present invention;

FIG. 3A is a network configuration diagram illustrating a location registration process for a mobile terminal, performed in a wireless packet network according to an embodiment of the present invention;

FIG. 3B is a signaling diagram illustrating a location registration process for a mobile terminal, performed in a wireless packet network according to an embodiment of the present invention;

FIG. 4A is a network configuration diagram illustrating a location deregistration process for a mobile terminal, performed in a wireless packet network according to an embodiment of the present invention;

FIG. 4B is a signaling diagram illustrating a location deregistration process for a mobile terminal, performed in a wireless packet network according to an embodiment of the present invention;

FIG. 5A is a network configuration diagram illustrating a call setup process from a wireless packet network to a mobile communication network according to an embodiment of the present invention;

FIG. 5B is a signaling diagram illustrating a call setup process from a wireless packet network to a mobile communication network according to an embodiment of the present invention;

FIG. 6A is a network configuration diagram illustrating a call setup process from a mobile communication network to a wireless packet network according to an embodiment of the present invention;

FIG. 6B is a signaling diagram illustrating a call setup process from a mobile communication network to a wireless packet network according to an embodiment of the present invention;

FIG. 7A is a network configuration diagram illustrating a call setup process between wireless packet networks belonging to different domains according to an embodiment of the present invention;

FIG. 7B is a signaling diagram illustrating a call setup process between wireless packet networks belonging to different domains according to an embodiment of the present invention;

FIG. 8 is a block diagram illustrating a configuration of a network interworking system for providing SMS service between heterogeneous networks according to another embodiment of the present invention;

FIG. 9 is a block diagram illustrating a structure of the packet switch shown in FIG. 8;

FIG. 10A is a network configuration diagram illustrating an SMS message transmission process from a wireless packet network to a mobile communication network according to another embodiment of the present invention;

FIG. 10B is a signaling diagram illustrating an SMS message transmission process from a wireless packet network to a mobile communication network according to another embodiment of the present invention;

FIG. 11A is a network configuration diagram illustrating an SMS message transmission process from a mobile communication network to a wireless packet network according to another embodiment of the present invention;

FIG. 11B is a signaling diagram illustrating an SMS message transmission process from a mobile communication network to a wireless packet network according to another embodiment of the present invention;

FIG. 12A is a network configuration diagram illustrating an SMS message transmission process between wireless packet networks belonging to different domains according to another embodiment of the present invention; and

FIG. 12B is a signaling diagram illustrating an SMS message transmission process between wireless packet networks belonging to different domains according to another embodiment of the present invention.

### DETAILED DESCRIPTION OF EXEMPLARY EMBODIMENTS

Several exemplary embodiments of the present invention will now be described in detail with reference to the annexed drawings. In the following description, a detailed description of known functions and configurations incorporated herein has been omitted for clarity and conciseness.

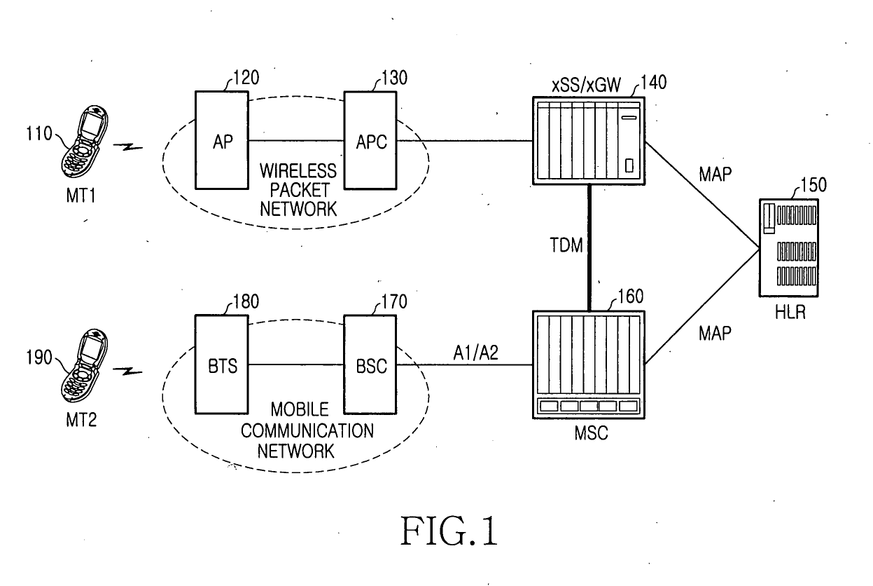

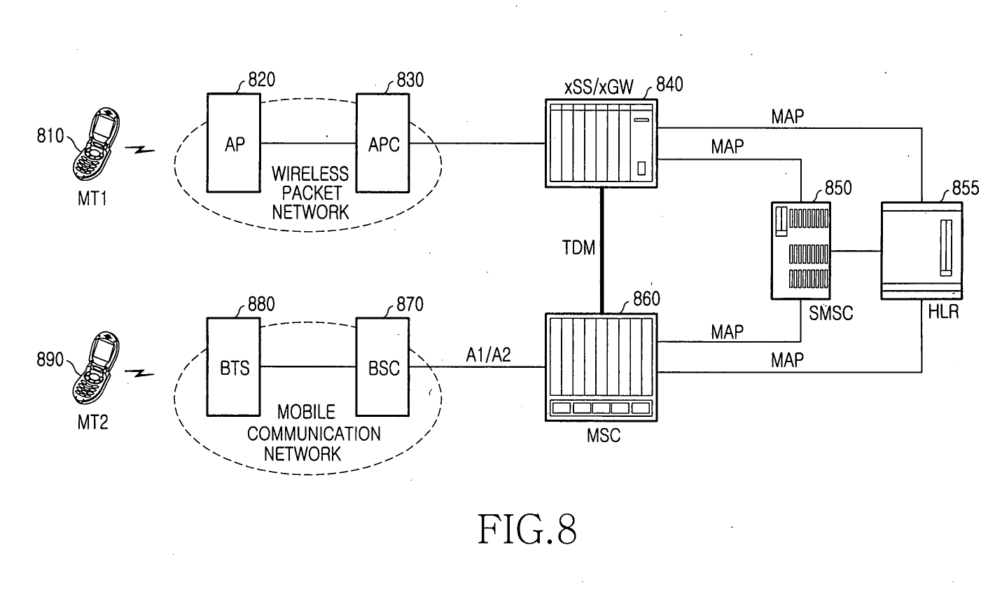

Herein, with reference to FIGS. 1 through 7, a description will be made of a first embodiment of the present invention for connecting a voice call between a wireless packet network and a voice communication network or connecting a voice call between wireless packet networks. With reference to FIGS. 8 through 12, a description will be made of a second embodiment for transmitting an SMS message between a wireless packet network and a voice communication network or transmitting an SMS message between wireless packet networks.

FIG. 1 is a block diagram illustrating a configuration of a network interworking system between heterogeneous networks according to an embodiment of the present invention.

In FIG. 1, a wireless packet network comprises substantially all wireless networks that are capable of providing not only IP-based packet service but also VoIP service to subscribers, such as an IEEE 802.1x or IEEE 802.2x-based WLAN or an IEEE 802.16e-based WiBro network. In addition, a mobile communication network refers to a conventional wireless network for providing circuit-switched voice service through a mobile switching center (MSC). Further, mobile terminals MT1 110 and MT2 190 comprise not only dedicated terminals for accessing only one of a particular mobile communication network and a wireless packet network and performing communication with the corresponding network, but also comprise dual-mode terminals that are capable of accessing not only the general mobile communication network but also the wireless packet network such as WLAN or WiBro.

Herein, the dual-mode terminal comprises not only a terminal that is capable of making an individual access to a corresponding network during every mode switching, but also comprises a terminal for a communication system supporting, for example, Home LAN service for installing a wireless packet network having narrower coverage in a cell region of the mobile communication network, in which a subscriber currently receiving circuit-switched communication service can receive packet-switched communication service after moving to the wireless packet network and wherein a subscriber currently receiving the packet-switched communication service can receive the circuit-switched communication service after moving to coverage of the mobile communication network, thereby providing seamless service to the subscribers.

For convenience, in FIG. 1, a plurality of mobile terminals are divided into a first mobile terminal MT1 110 for accessing a wireless packet network and receiving VoIP service from the wireless packet network, and a second mobile terminal MT2 190 for accessing a mobile communication network and receiving a voice service from the mobile communication network via a mobile switching center (MSC). The VoIP service and voice service can comprise various additional services in addition to the basic origination/termination service. The first mobile terminal MT1 110 accesses the wireless packet network using a SIP, and the SIP refers to a protocol used in an Internet multimedia subsystem (IMS) for allowing a mobile terminal to access a core network of another communication network such as a mobile communication network or a PSTN through a gateway and providing IP-based communication service to subscribers.

In an embodiment of the present invention, the first mobile terminal MT1 110 uses a Mobile Identification Number (MIN) or an International Mobile Subscriber Identity (IMSI) as a terminal identifier. Further, the first mobile terminal MT1 110 uses the terminal identifier for a SIP Uniform Resource Locator (URL), and includes at least one of an Electronic Serial Number (ESN), a MIN and an IMSI in a specific field of a SIP Registration Request message during location registration, and transmits the SIP Registration Request message to a packet switch (xSS/xGW) 140 described in greater detail below. In an exemplary embodiment of the present invention, it will be assumed for illustration purposes that the MIN is used as the terminal identifier, but the present invention is not limited thereto.

For origination request, the first mobile terminal MT1 110 can transmit an ESN along with a SIP URL. The ESN is used to authenticate an authorized subscriber in a home location register (HLR), and the ESN can be optionally included in an origination message. In addition, the first mobile terminal MT1 110 transmits a SIP Invite Request message for requesting call setup to the packet switch 140 during origination, and receives a SIP Invite Request message of the other party's terminal delivered from the packet switch 140 during termination.

In the wireless packet network of FIG. 1, the first mobile terminal MT1 110 accesses the wireless packet network through an access point (AP) 120 for connecting a wireless network to a wire network, and an access point controller (APC) 130 for controlling packet communication, and receives not only packet service but also VoIP service from the wireless packet network. Herein, the first mobile terminal MT1 110 using the VoIP service sets up a call through the SIP-based softswitch system and gateway (xSS/xGW), and performs voice communication with another mobile terminal in the wireless packet network or the second mobile terminal MT2 190 in the mobile communication network. Herein, for convenience, a network entity including the softswitch system and the gate will be referred to as the packet switch (xSS/xGW) 140.

The packet switch 140 delivers an Interim Standard (IS)-41 Mobile Application Part (MAP) message to an HLR 150 so that the HLR 150 can perform location registration on the first mobile terminal MT1 110. The packet switch 140 connects a bearer for traffic transmission during subscriber's call setup, releases the bearer during call release, and handles transmission of SIP messages for subscriber's call setup/release. In addition, the packet switch 140 performs location detection on a called terminal through transmission/reception of a SIP message and a MAP message for call transfer between a mobile communication network and a wireless packet network, and data conversion for data transmission. A detailed description of the packet switch 140 will be provided in greater detail below.

In the mobile communication network of FIG. 1, the second mobile terminal MT2 190 accesses the mobile communication network via a base transceiver subsystem (BTS) 180 and a base station controller (BSC) 170 for controlling the BTS 180, and receives the general circuit-switched voice service from the mobile communication network. Herein, the second mobile terminal MT2 190 using the voice service sets up a call through an MSC 160 and performs voice communication with another mobile terminal in the mobile communication network, or sets up a call through the packet switch 140 and performs voice communication with the first mobile terminal MT1 110 in the wireless packet network.

Herein, when the first mobile terminal MT1 110 transmits a call setup request to the second mobile terminal MT2 190 in the mobile communication network, the MSC 160 receives an Initial Address Message (IAM) message from the packet switch 140 in the wireless packet network, and transmits a Paging Request message to the second mobile terminal MT2 190 using call setup information included in the IAM message. When the second mobile terminal MT2 190 responds to the call setup request, the MSC 160 transmits an Answer Message (ANM) message, which is an off-hook message, to the packet switch 140, to thereby inform of the call setup to the second mobile terminal MT2 190. The IAM message is used for Signaling System No. 7 (SS7) signaling during Integrated Service Digital Network User Part (ISUP) call setup.

In addition, when the second mobile terminal MT2 190 transmits a call setup request to the first mobile terminal MT1 110 in the wireless packet network, the MSC 160 transmits an IAM message to the packet switch 140 in the wireless packet network, and upon receiving the IAM message, the packet switch 140 transmits a SIP Invite Request message to the first mobile terminal MT1 110 using call setup information included in the IAM message. When the first mobile terminal MT1 110 responds to the call setup request, the MSC 160 receives an ANM message, which is an off-hook message, from the packet switch 140, and informs the second mobile terminal MT2 190 of the call setup to the first mobile terminal MT1 110.

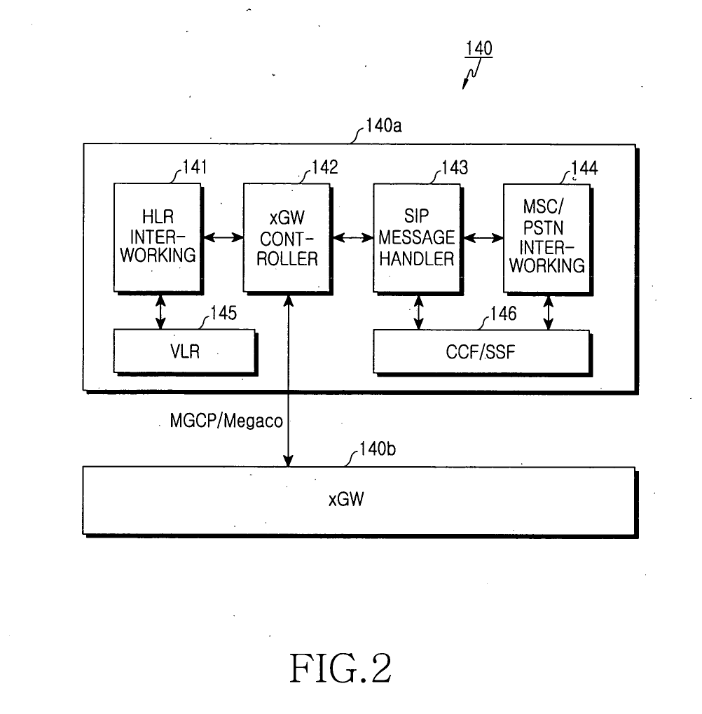

With reference to FIG. 2, a detailed description will now be made of the packet switch 140.

FIG. 2 is a block diagram illustrating a structure of a packet switch according to an embodiment of the present invention. The packet switch 140 comprises a softswitch system (xSS) 140a for performing location registration on a mobile terminal using a MAP message and handling transmission of SIP messages for subscriber's call setup/release, and a gateway (xGW) 140b, connected to the softswitch system 140a via a Media Gateway Control Protocol (MGCP)/MEGACO, well known to those skilled in the art as a gateway control protocol, for performing data conversion (or data interpretation) between the mobile communication network and the wireless packet network. A media gateway (MGW) can be used as the gateway 140b, and because its structure is well known to those skilled in the art, a detailed description thereof will be omitted herein for simplicity.

The softswitch system 140a comprises an HLR interworking unit 141 for performing location registration on a mobile terminal, an xGW controller 142 for handling bearer connection/release by controlling the gateway 140b, a SIP message handler 143 for handling a SIP message for subscriber's call setup/release, an MSC/PSTN interworking unit 144 for exchanging IAM messages with an MSC 160 for a called terminal or a calling terminal, a visitor location register (VLR) 145, and a call control function (CCF)/service switching function (SSF) 146 for handling subscriber's call state and additional service.

During location registration for the first mobile terminal MT1 110, the HLR interworking unit 141 receives a SIP Registration Request message, transmits the received SIP Registration Request message to the HLR 150 where a subscriber profile is stored, receives the subscriber profile from the HLR 150 in response thereto, and registers the location of the subscriber in the VLR 145. The HLR interworking unit 141 can use, for example, IS-41 MAP as a signaling protocol for interworking with the HLR 150. Upon receipt of a call setup/release signal from the SIP message handler 143 or the MSC/PSTN interworking unit 144, the xGW controller 142 exchanges control signals for connecting or releasing a bearer to/from the gateway 140b with the SIP message handler 143 or the MSC/PSTN interworking unit 144.

The SIP message handler 143 handles call connection/release or handles SIP messages used for providing various additional services. The MSC/PSTN interworking unit 144 controls call connection service to a corresponding MSC 160 or an undepicted PSTN according to a location of a called terminal. That is, if receipt of a SIP Invite Request message including a MIN of a called terminal is detected by the SIP message handler 143 and a location of the called terminal is detected by the HLR interworking unit 141 using the MIN, the MSC/PSTN interworking unit 144 transmits an IAM message including call setup information to the MSC 160 in which the called terminal is located, for call connection from the wireless packet network to the mobile communication network.

In addition, if an IAM message including call setup information is received from the MSC 160 where a calling terminal is located, the MSC/PSTN interworking unit 144 transmits a SIP Invite Request message to a corresponding called terminal via the SIP message handler 143, for call connection from the mobile communication network to the wireless packet network. The VLR 145 stores a subscriber profile provided from the HLR interworking unit 141 during location registration for a mobile terminal. The CCF/SSF 146 manages a subscriber's call state by interworking with the MSC/PSTN interworking unit 144 and the SIP message handler 143, and controls various additional services.

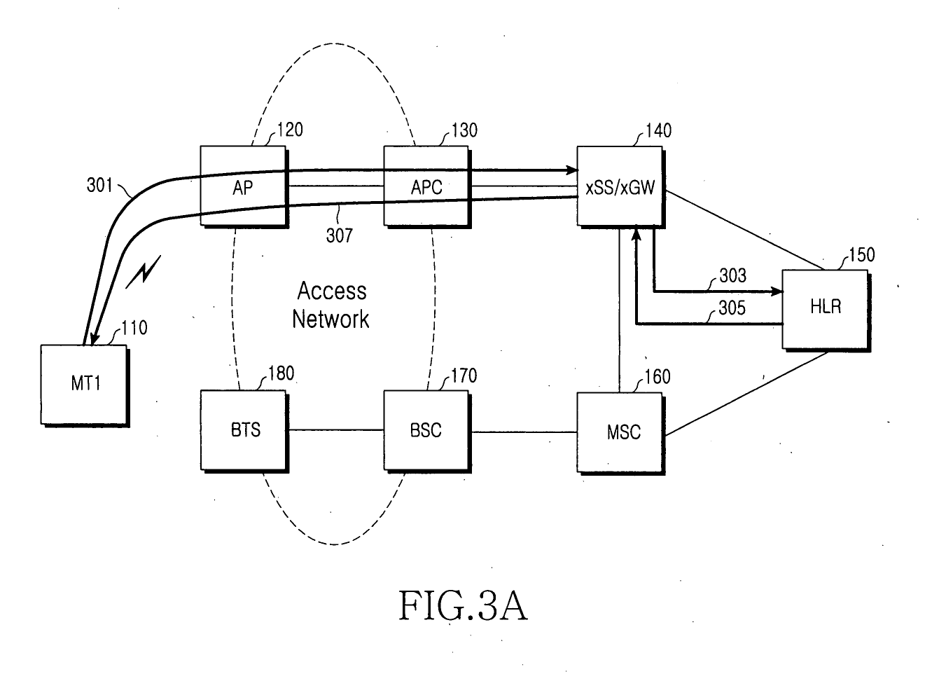

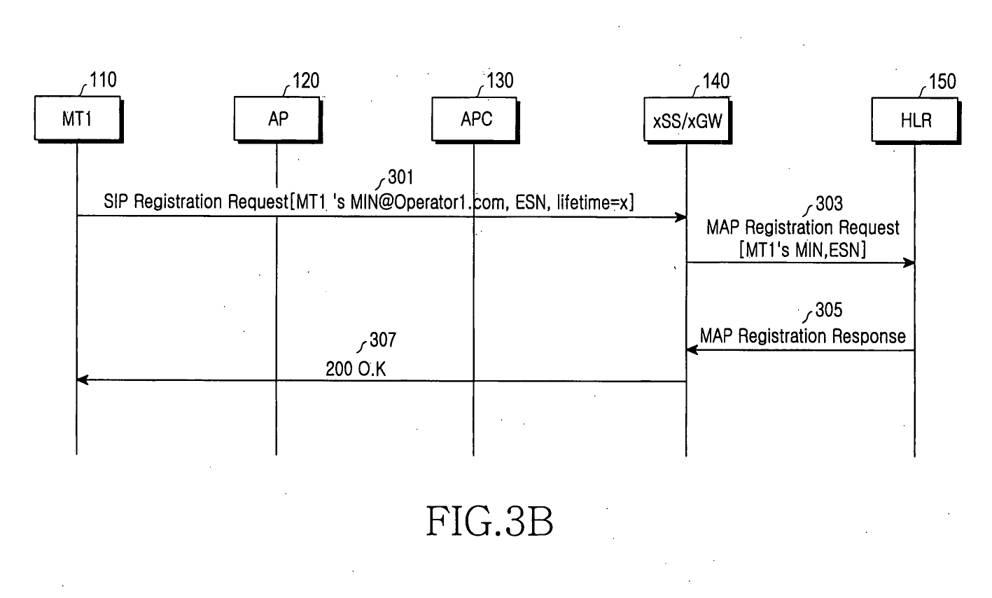

With reference to FIGS. 3 through 7, a detailed description will now be made of an exemplary location registration/deregistration operation for a mobile terminal, an exemplary origination/termination operation between a wireless packet network and a mobile communication network, and an exemplary origination/terinination operation between wireless packet networks, all of the operations being performed through the network interworking system of FIG. 1. In the drawings, the same or similar elements are denoted by the same reference numerals even though they are depicted in different drawings. In FIGS. 3 through 7, an access network comprises both a wireless packet network and a mobile communication network, to each of which a mobile terminal is connected.

FIG. 3A is a network configuration diagram illustrating a location registration process for a mobile terminal, performed in a wireless packet network according to an embodiment of the present invention, and FIG. 3B is a signaling diagram illustrating the location registration process.

In step 301, a first mobile terminal MT1 110 transmits a SIP Registration Request message with lifetime=x including, for example, its own MIN and ESN to a packet switch 140 via an AP 120 and an APC 130 when it is powered On in a wireless packet network. The SIP Registration Request message with lifetime=x further includes a lifetime field indicating a terminal's location registration period, which is set to ‘x’ (lifetime=x). Herein, the MIN is preferably transmitted in a URL form.

Upon receiving the SIP Registration Request message with lifetime=x, the packet switch 140 transmits in step 303 a MAP Registration Request message including an MIN and an ESN for location registration for the first mobile terminal MT1 110 to an HLR 150 to request transmission of a subscriber profile. In step 305, the HLR 150 transmits a subscriber profile for the first mobile terminal MT1 110 to the packet switch 140 through a MAP Registration Response message. Then the packet switch 140 stores the corresponding subscriber profile in a VLR 145, performing location registration. Herein, the MAP Registration Request/Response messages are transmitted/received using, for example, an IS-41 protocol.

After completing the location registration using the received MAP Registration Response message, the packet switch 140 transmits in step 307 a SIP OK message (or 200 O.K message) to the first mobile terminal MT1 110, indicating the successful completion of the location registration for the first mobile terminal MT1 110.

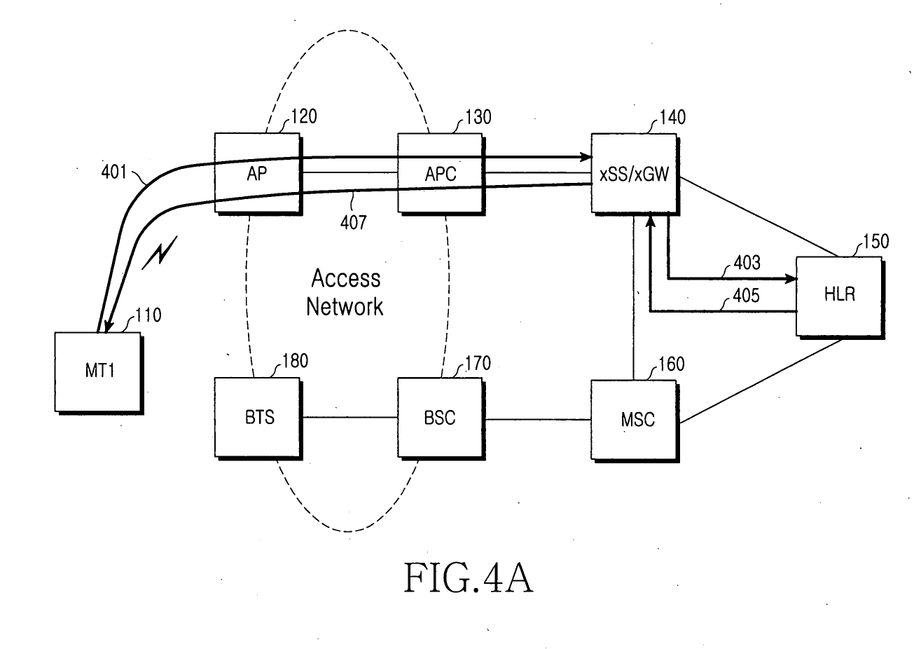

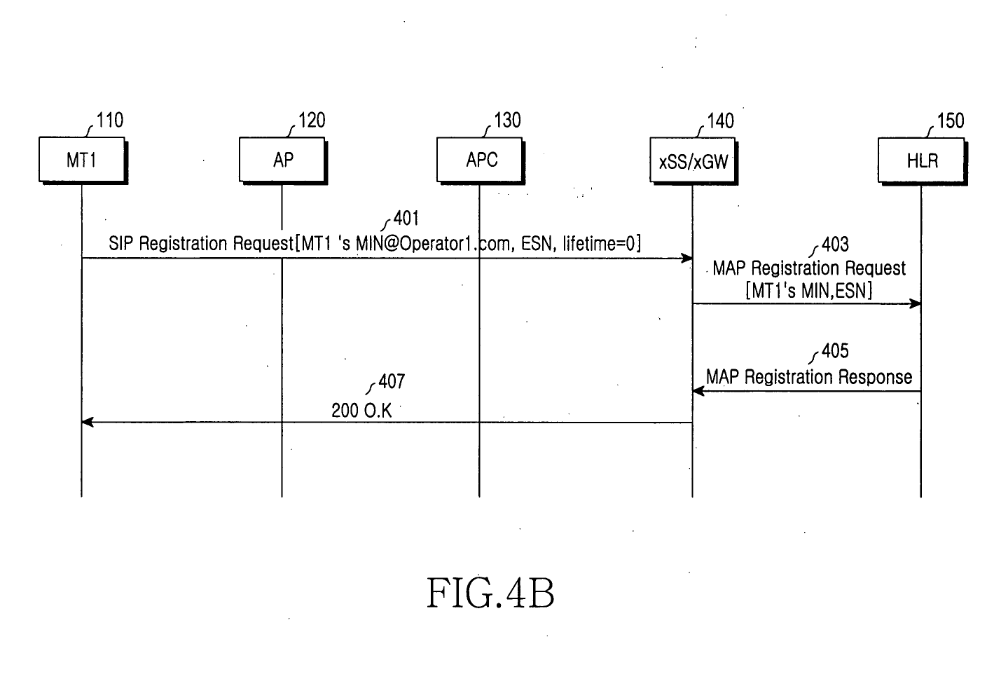

FIG. 4A is a network configuration diagram illustrating a location deregistration process for a mobile terminal, performed in a wireless packet network according to an embodiment of the present invention, and FIG. 4B is a signaling diagram illustrating the location deregistration process.

In step 401, a first mobile terminal MT1 110 transmits a SIP Registration Request message with lifetime=0 including, for example, its own MIN1 and ESN to a packet switch 140 via an AP 120 and an APC 130 when it is powered Off in a wireless packet network. The SIP Registration Request message with lifetime=0 further includes a lifetime field indicating a terminal's location registration period, which is set to ‘0’ (lifetime=0), and the MIN1 is preferably transmitted in a URL form.

Upon receiving the SIP Registration Request message with lifetime=0, the packet switch 140 transmits in step 403 a MAP Registration Request message including an MIN and an ESN for location deregistration for the first mobile terminal MT1 110 to an HLR 150 to request transmission of a subscriber profile. In step 405, the HLR 150 transmits a subscriber profile for the first mobile terminal MT1 110 to the packet switch 140 through a MAP Registration Response message. Then the packet switch 140 performs a location deregistration process by analyzing a corresponding subscriber profile location-registered in the VLR 145. Herein, the MAP Registration Request/Response messages are transmitted/received using, for example, an IS-41 protocol.

After completing the location deregistration using the received MAP Registration Response message, the packet switch 140 transmits in step 407 a SIP OK message (or 200 O.K message) to the first mobile terminal MT1 110, indicating the successful completion of the location deregistration for the first mobile terminal MT1 110.

Because a location registration/deregistration process for the second mobile terminal MT2 190 connected to a mobile communication network is well known to those skilled in the art, a detailed description thereof will be omitted herein for simplicity.

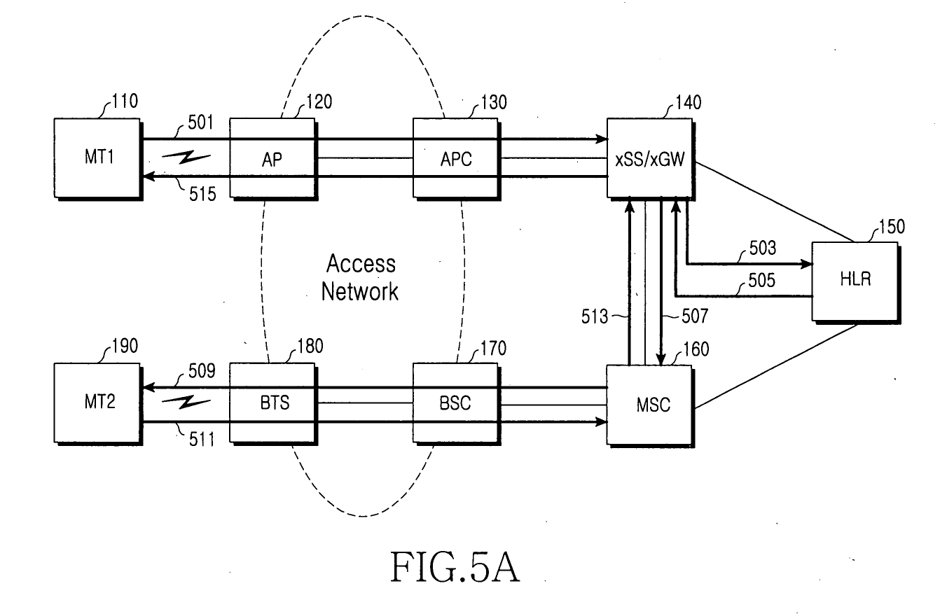

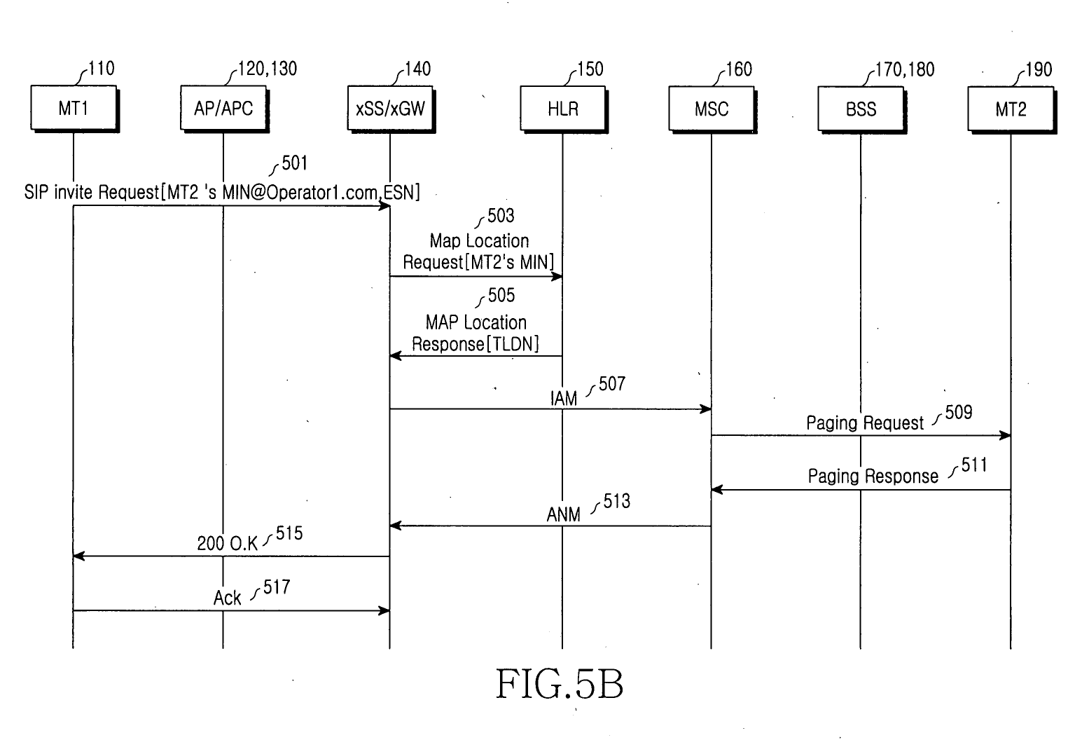

FIG. 5A is a network configuration diagram illustrating a call setup process from a wireless packet network to a mobile communication network according to an embodiment of the present invention, and FIG. 5B is a signaling diagram illustrating the call setup process. In the call setup process, a first mobile terminal MT1 110 in the wireless packet network transmits a voice call request to a second mobile terminal MT2 190 in the mobile communication network.

It is assumed for illustration purposes in FIG. 5A that the first mobile terminal MT1 110 is a calling terminal connected to the wireless packet network and the second mobile terminal MT2 190 is a called terminal connected to the mobile communication network. For convenience, in FIG. 5B, a BTS 180 and a BSC 170 are denoted by a base station system (BSS).

In step 501, the first mobile terminal MT1 110, a calling terminal, transmits a SIP Invite Request message including an MIN2 of the second mobile terminal MT2 190, a called terminal, and its own ESN to a packet switch 140 through an AP 120 and an APC 130 to request call setup with the second mobile terminal MT2 190. Herein, the MIN2 is preferably transmitted in a URL form.

Upon receiving the SIP Invite Request message, the packet switch 140 transmits in step 503 a MAP Location Request message including the MIN2 and the ESN to an HLR 150, to detect an MSC 160 in which the second mobile terminal MT2 190 is registered. In step 505, the HLR 150 determines whether the first mobile terminal MT1 110 is a registered terminal by analyzing the ESN, and then transmits a Temporary Local Directory Number (TLDN) indicating location information of the MSC 160 in which the second mobile terminal MT2 190 is registered, to the packet switch 140 using a MAP Location Response message, if it is determined that the first mobile terminal MT1 110 is a registered terminal.

Upon receiving the TLDN, the packet switch 140 transmits in step 507 an IAM message for voice call connection to the MSC 160 detected based on the TLDN. In step 509, the MSC 160 transmits a Paging Request message indicating the call arrival to the second mobile terminal MT2 190 through a BSS 170 and 180. Upon receiving the Paging Request message, the second mobile terminal MT2 190 transmits in step 511 a Paging Response message for approving the paging request to the MSC 160 via the BSS 170 and 180. In step 513, the MSC 160 transmits to the packet switch 140 an ANM message indicating completion of the voice call setup to the second mobile terminal MT2 190.

Thereafter, in step 515, the packet switch 140 transmits a SIP O.K message (or 200 O.K message) to the first mobile terminal MT1 110 indicating the successful call setup to the second mobile terminal MT2 190. In step 517, the packet switch 140 receives an acknowledgement (Ack) message from the first mobile terminal MT1 110, completing the call setup to the mobile communication network.

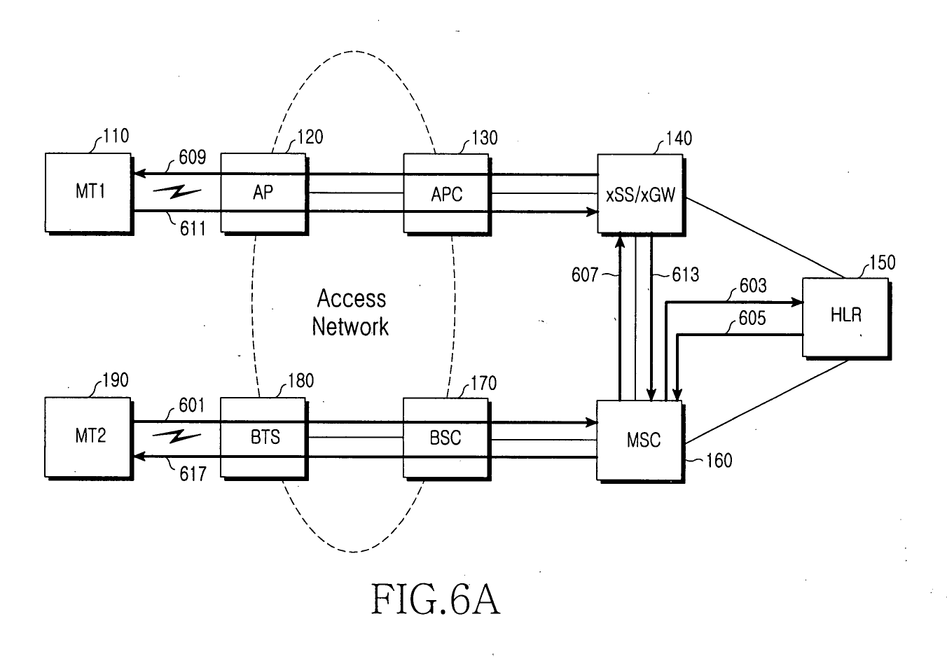

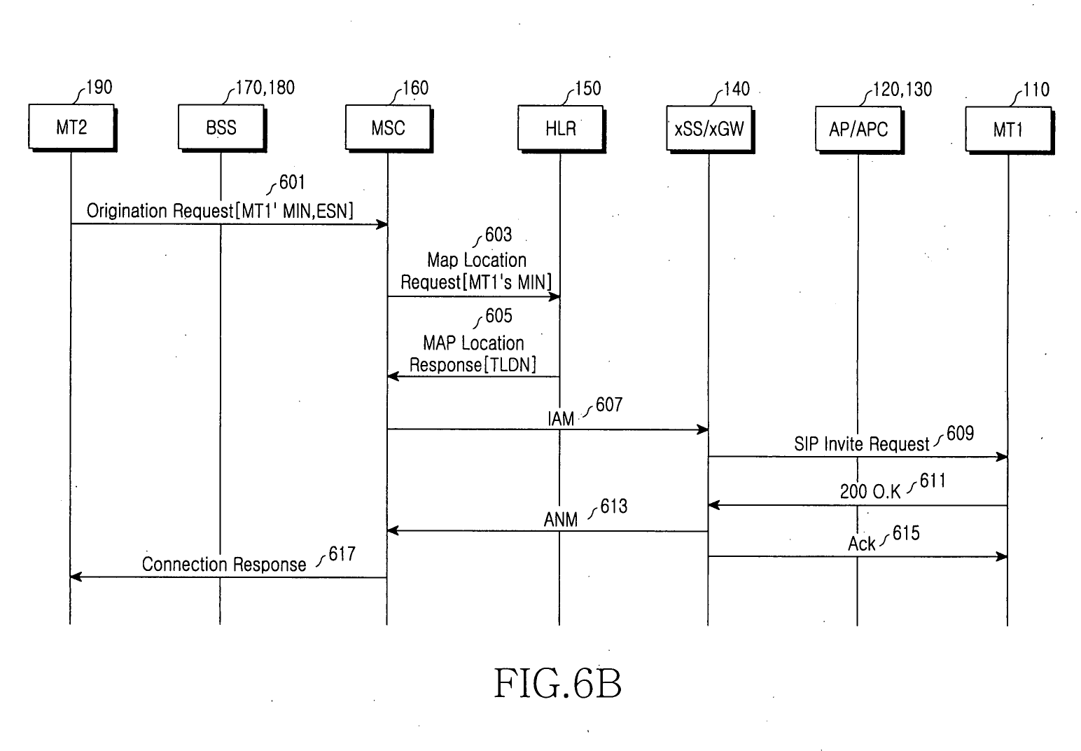

FIG. 6A is a network configuration diagram illustrating a call setup process from a mobile communication network to a wireless packet network according to an embodiment of the present invention, and FIG. 6B is a signaling diagram illustrating the call setup process. In the call setup process, a second mobile terminal MT2 190 in the mobile communication network transmits a voice call request to a first mobile terminal MT1 110 in the wireless packet network.

It is assumed for illustration purposes in FIG. 6A that the second mobile terminal MT2 190 is a calling terminal connected to the mobile communication network and the first mobile terminal MT1 110 is a called terminal connected to the wireless packet network. For convenience, in FIG. 6B, a BTS 180 and a BSC 170 are denoted by a BSS.

In step 601, the second mobile terminal MT2 190, a calling terminal, transmits an Origination Request message including an MIN1 of the first mobile terminal MT1 110, a called terminal, and its own ESN to an MSC 160 via a BSS 170 and 180 to request call setup with the first mobile terminal MT1 110. Herein, the MIN1 is preferably transmitted in a URL form. The ESN is transmitted to an HLR 150 for subscriber authentication. Upon receiving the Origination Request message, the MSC 160 transmits in step 603 a MAP Location Request message including the MIN1 to an HLR 150 to detect a location of the first mobile terminal MT1 110.

In step 605, the HLR 150 determines whether the second mobile terminal MT2 190 is a registered terminal by analyzing the ESN, and then transmits a TLDN of a packet switch 140, indicating location information of the first mobile terminal MT1 110 to the MSC 160 using a MAP Location Response message if it is determined that the second mobile terminal MT2 190 is a registered terminal. Upon receiving the TLDN, the MSC 160 transmits in step 607 an IAM message for voice call connection to the packet switch 140 detected based on the TLDN. In step 609, the packet switch 140 transmits a SIP Invite Request message indicating the call arrival to the first mobile terminal MT1 110 via an APC 130 and an AP 120.

Upon receiving the SIP Invite Request message, the first mobile terminal MT1 110 transmits a SIP O.K message (or 200 O.K message) for approving the call connection, to the packet switch 140 via the AP 120 and the APC 130. In step 613, the packet switch 140 transmits an ANM message indicating the completion of the voice call setup to the first mobile terminal MT1 110, to the MSC 160 in the origination side. In step 615, the packet switch 140 transmits an Ack message to the first mobile terminal MT1 110 in response to the SIP O.K message. Upon receiving the ANM message, the MSC 160 transmits in step 617 a Connection Response message to the second mobile terminal MT2 190 indicating the successful call setup to the first mobile terminal MT1 110.

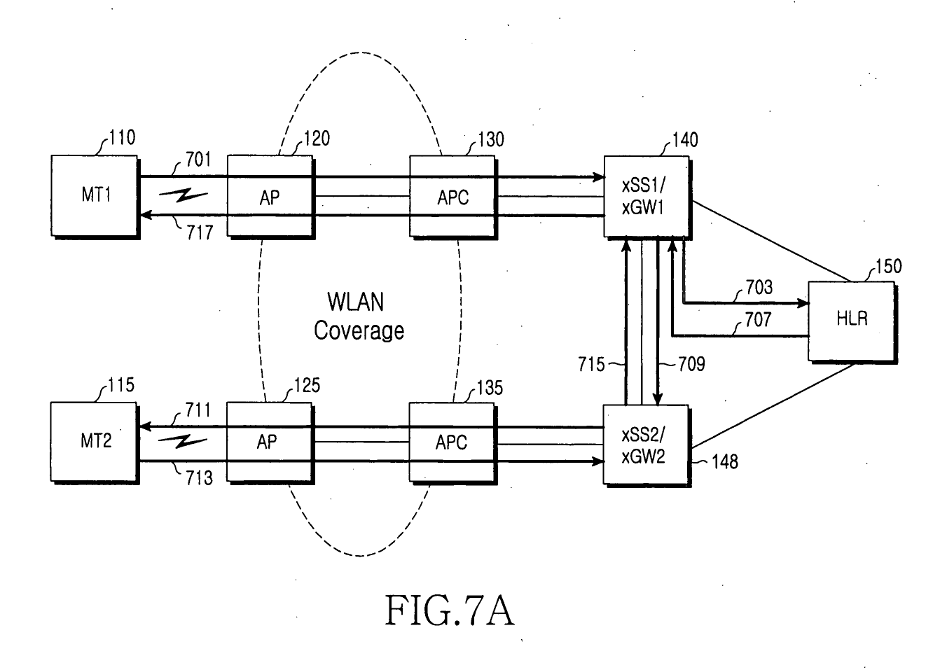

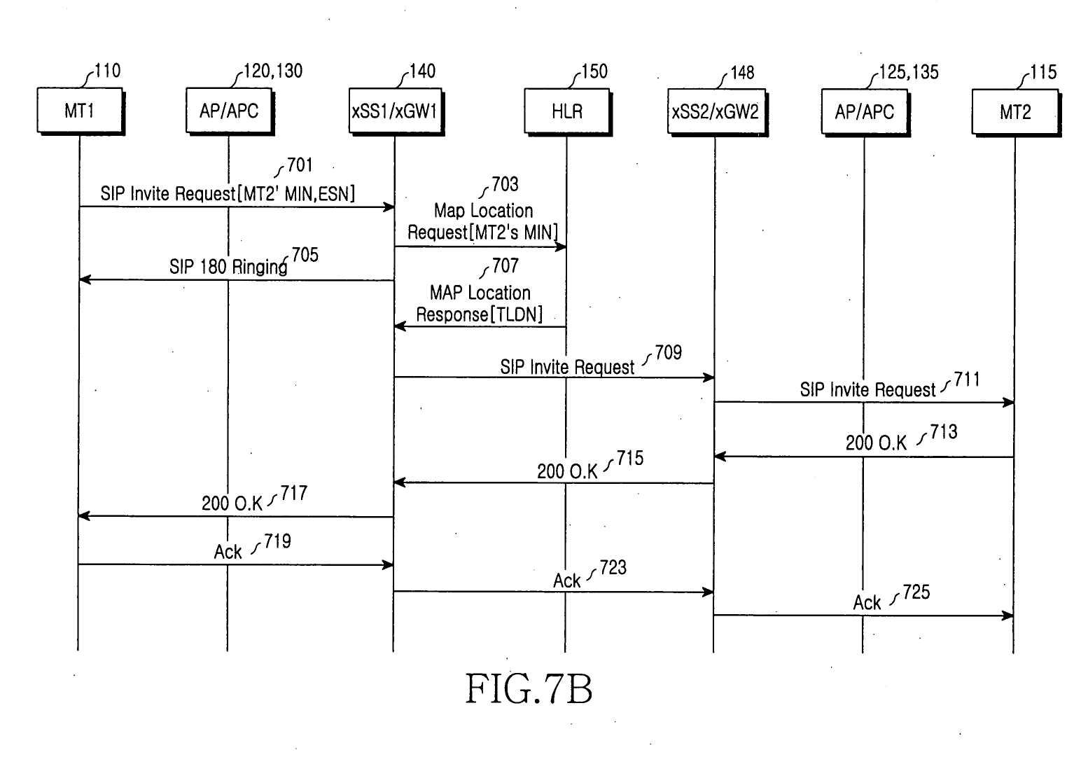

FIG. 7A is a network configuration diagram illustrating a call setup process between wireless packet networks belonging to different domains according to an embodiment of the present invention, and FIG. 7B is a signaling diagram illustrating the call setup process. In the call setup process, a first mobile terminal MT1 110 connected to a first wireless packet network transmits a voice call request to a second mobile terminal MT2 115 connected to a second wireless packet network.

In FIG. 7A, the first and second wireless packet networks comprise first and second packet switches (xSS1/xGW1) 140 and (xSS2/xGW2) 148 for connecting/releasing a VoIP-based voice call, respectively, and the first and second packet switches 140 and 148 both have the structure described in connection with FIG. 2.

In step 701, the first mobile terminal MT1 110, a calling terminal, transmits a SIP Invite Request message including an MIN2 of the second mobile terminal MT2 115, a called terminal, and its own ESN to a first packet switch 140 through an AP 120 and an APC 130, to request call setup with the second mobile terminal MT2 115. Herein, the MIN2 is preferably transmitted in a URL form. The ESN is transmitted to an HLR 150.

Upon receiving the SIP Invite Request message, the first packet switch 140 transmits in step 703 a MAP Location Request message including the MIN2 to the HLR 150, to detect a packet switch in which the second mobile terminal MT2 115 is registered. Thereafter, in step 705, the first packet switch 140 transmits a SIP 180 Ringing signal to the first mobile terminal MT1 110. In step 707, the HLR 150 determines whether the first mobile terminal MT1 110 is a registered terminal by analyzing the ESN, and then transmits a TLDN of a second packet switch 148, indicating information on a location where the second mobile terminal MT2 115 is registered, to the first packet switch 140 if it is determined that the first mobile terminal MT1 110 is a registered terminal.

Upon receiving the TLDN, the first packet switch 140 transmits in step 709 a SIP Invite Request message for voice call connection to the second packet switch 148 detected based on the TLDN. In step 711, the second packet switch 148 transmits a SIP Invite Request message indicating the call arrival to the second mobile terminal MT2 115 via an APC 135 and an AP 125. Upon receiving the SIP Invite Request message, the second mobile terminal MT2 115 transmits in step 713 a SIP O.K message (or 200 O.K message) for approving the call setup request to the second packet switch 145.

In step 715, the second packet switch 145 transmits a SIP O.K message (or 200 O.K message) indicating the completion of the voice call setup to the first packet switch 140. Similarly, in step 717, the first packet switch 140 transmits a SIP O.K message (or 200 O.K message) to the first mobile terminal MT1 110. Thereafter, in steps 719 through 725, an Ack message from the first mobile terminal MT1 110 is delivered to the second mobile terminal MT2 115 via the first and second packet switches 140 and 148, and the first and second mobile terminals MT1 110 and MT2 115 perform voice communication with each other via the first and second packet switches 140 and 148.

FIG. 8 is a block diagram illustrating an exemplary configuration of a network interworking system for providing SMS service between heterogeneous networks according to another embodiment of the present invention.

In FIG. 8, a first mobile terminal MT1 810 comprises a terminal that is capable of accessing a wireless packet network, and a second mobile terminal MT2 890 comprises a terminal that is capable of accessing a mobile communication network. A dual-mode terminal that is capable of accessing both the wireless packet network and the mobile communication network can be used as each of the first and second mobile terminals MT1 810 and MT2 890, as described in connection with FIG. 1. Herein, for convenience, the first and second mobile terminals MT1 810 and MT2 890 are divided into a first mobile terminal MT1 810 for accessing a wireless packet network to receive packet service and/or SMS service from the wireless packet network, and a second mobile terminal MT2 890 for accessing a mobile communication network and receiving voice service and/or SMS service from the mobile communication network.

The wireless packet network of FIG. 8 includes IEEE 802.1x or IEEE 802.2x-based WLAN or an IEEE 802.16e-based WiBro network, and comprises a packet switch (xSS/xGW) 840 and an SMS center (SMSC) 850 so as to provide not only IP-based packet service but also SMS service used in the mobile communication network to subscribers. The mobile communication network of FIG. 8 further comprises an MSC 860 and the SMSC 850 so as to provide not only the general voice service but also SMS service to subscribers. The SMSC 850 may be included in the wireless packet network. In an embodiment of the present invention, both the SMSC 850 and an HLR 855 for location registration and location information detection for the mobile terminals MT1 810 and MT2 890 are shared by the wireless packet network and the mobile communication network. The first mobile terminal MT1 810 accesses the wireless packet network using a SIP.

In an embodiment of the present invention, when transmitting an SMS message to a called terminal, the first mobile terminal MT1 810 in the wireless packet network transmits a MIN of the called terminal in a SIP URL form. The first mobile terminal MT1 810 can transmit a SIP Message Request message including a SIP URL and/or an IMSI of the called terminal to the packet switch 840, together with an input SMS message. In addition, when requesting origination of an SMS message, the first mobile terminal MT1 810 can transmit the SIP URL and its own ESN together. When there is an SMS message originated from the mobile communication network, the first mobile terminal MT1 810 receives a SIP Message Request message transmitted by the calling terminal, from the packet switch 840.

In the wireless packet network of FIG. 8, the first mobile terminal MT1 810 accesses the wireless packet network via an AP 820 for connecting a wireless network to a wire network and an APC 830 for controlling packet communication, and receives SMS service as well as packet service. The packet switch 840 including a SIP-based softswitch system (xSS) and gateway (xGW) connected to the first mobile terminal MT1 810 supporting the SMS service, accesses the SMSC 850 for repeating SMS message transmission, and handles transmission/reception of SMS messages to/from another mobile terminal in the wireless packet network or the second mobile terminal MT2 890 in the mobile communication network.

The packet switch 840 performs communication with the SMSC 850 provided for SMS message transmission, using, for example, an IS-41 MAP. Upon receiving a request for transmission of an SMS message to the second mobile terminal MT2 890 from the first mobile terminal MT1 810 connected to the wireless packet network, the packet switch 840 transmits to the SMSC 850 an IS-41 MAP-based SMS Delivery Point To Point (SMDPP) message for requesting SMS message transmission, along with the corresponding SMS message. Herein, the term “delivery message” has the same meaning as the term “SMDPP message.”

Upon receiving a request for transmission of an SMS message to the first mobile terminal MT1 810 from the second mobile terminal MT2 890 connected to the mobile communication network, the packet switch 840 receives an IS-41 MAP-based SMDPP message for requesting SMS message transmission, along with the corresponding SMS message, and transmits a SIP Message Request message including a SIP URL to the first mobile terminal MT1 810. When the first mobile terminal MT1 810 responds to the SIP Message Request message, the packet switch 840 transmits an SMS message delivered from the SMSC 850 to the first mobile terminal MT1 810.

For the foregoing exemplary operation, the packet switch 840 comprises a VLR for storing a subscriber profile delivered from the HLR 855 during location registration for the first and second mobile terminals MT1 810 and MT2 890, transmits a request for SMS message delivery between the mobile communication network and the wireless packet network to the SMSC 850 through transmission/reception of SIP message and SMDPP message, and performs data conversion for data transmission between the mobile communication network and the wireless packet network. The packet switch 840 serves as a SIP proxy, and can support CCF/SSF for supporting additional services of the MSC 860. A detailed description of the packet switch 840 will be provided below.

A location registration/deregistration process for the first mobile terminal MT1 810 connected to the wireless packet network is performed in the process described with reference to FIGS. 4A and 4B, and because a location registration/deregistration process for the second mobile terminal (MT2) 890 connected to the mobile communication network is well known to those skilled in the art, a detailed description thereof will be omitted herein for simplicity.

In FIG. 8, the second mobile terminal 890 accesses the mobile communication network through a BTS 880 and a BSC 870 for controlling the BTS 880, and receives SMS service as well as the general circuit-switched voice service. The MSC 860, to which the second mobile terminal MT2 890 using the SMS service is connected, accesses the SMSC 850 for repeating SMS message transmission, and handles transmission/reception of SMS messages to/from another mobile terminal in the wireless packet network or the second mobile terminal MT2 890 in the mobile communication network.

In an embodiment of the present invention, when transmitting an SMS message of the first mobile terminal MT1 810, the MSC 860 receives an SMDPP message for requesting SMS message transmission from the SMSC 850, transmits a Paging Request message to the second mobile terminal MT2 890, which is a called terminal, and then transmits an SMS message delivered from the SMSC 850 to the second mobile terminal MT2 890 when the second mobile terminal MT2 890 responds to the Paging Request message. Upon receiving an Origination Request Message [SMD-Request] message for the first mobile terminal MT1 810 along with an SMS message from the second mobile terminal MT2 890, the MSC 860 transmits an SMDPP message for requesting SMS message transmission to the SMSC 850.

In an embodiment of the present invention, the SMSC 850 for repeating SMS message transmission between the wireless packet network and the mobile communication network and SMS message transmission between wireless packet networks belonging to different domains, receives address information of the MSC 860 or packet switch 840 in which a called terminal is located, i.e., address information of the called terminal, from the HLR 855, and transmits an SMS message to the called terminal belonging to the corresponding MSC 860 or packet switch 840. The SMSC 850 transmits a MIN using the SIP Message Request message and the Origination Request Message [SMD-Request] message so that the HLR 855 can acquire address information of the called terminal.

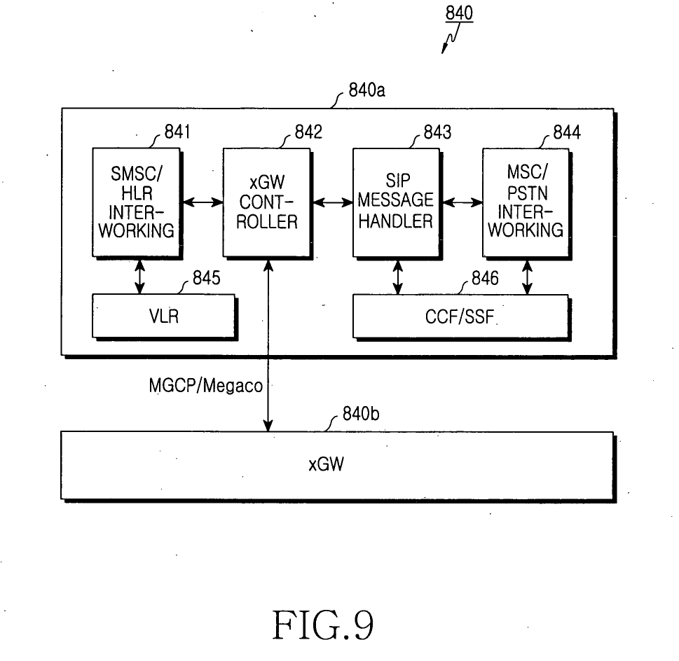

With reference to FIG. 9, a detailed description will now be made of the packet switch 840. Because the structure of the packet switch 840 related to voice service has been described in detail in the foregoing embodiment, a detailed description thereof will be omitted herein.

FIG. 9 is a block diagram illustrating a structure of the packet switch 840 shown in FIG. 8. The packet switch 840 comprises a softswitch system (xSS) 840a for performing location registration on a mobile terminal using an IS-41 MAP message (hereinafter referred to as a “MAP message”) and handling transmission of SMS messages and transmission of SIP messages for subscriber's call setup/release, and a gateway (xGW) 840b connected to the softswitch system 840a via a MGCP/MEGACO, well known to those skilled in the art as a gateway control protocol, for performing data conversion (or data interpretation) between the mobile communication network and the wireless packet network. A media gateway (MGW) can be used as the gateway 840b, and because its structure is well known to those skilled in the art, a detailed description thereof will be omitted herein for simplicity.

The softswitch system 840a comprises an SMSC/HLR interworking unit 841 having SMSC interworking means for exchanging SMDPP messages with the SMSC 850 for SMS message transmission between the wireless packet network and the mobile communication network and HLR interworking means for performing location registration/deregistration and location inquiry for a mobile terminal, an xGW controller 842 for handling bearer connection/release by controlling the gateway 840b, a SIP message handler 843 for handling a SIP message for SMS message delivery and subscriber's call setup/release, an MSC/PSTN interworking unit 844 for connection with the mobile communication network and the PSTN, a VLR 845, and a CCF/SSF 846 for handling subscriber's call state and additional service.

During location registration for the first mobile terminal MT1 810, the SMSC/HLR interworking unit 841, as described in connection with reference to FIG. 4A, receives a SIP Registration Request message, delivers the received SIP Registration Request message to the HLR 855 where a subscriber profile is stored, receives the subscriber profile from the HLR 855 in response thereto, and registers the location of the subscriber in the VLR 845. The SMSC/HLR interworking unit 841 can use, for example, IS-41 MAP as a signaling protocol for interworking with the HLR 855.

Upon receipt of a SIP Message Request message including a MIN of a called terminal through the SIP message handler 843 for SMS message delivery from the wireless packet network to the mobile communication network, the SMSC/HLR interworking unit 841 delivers an SMDPP message to the SMSC 850 to request transmission of an SMS message to the corresponding called terminal. In addition, upon receipt of an SMDPP message from the SMSC 850 for SMS message delivery from the mobile communication network to the wireless packet network, the SMSC/HLR interworking unit 841 transmits a SIP Message Request message to the corresponding called terminal through the SIP message handler 843, to inform of the transmission of the SMS message.

Upon receipt of a call setup/release signal for SMS message delivery from the SIP message handler 843 or the MSC/PSTN interworking unit 844, the xGW controller 842 exchanges control signals for connecting or releasing a bearer to/from the gateway 840b with the SIP message handler 843 or the MSC/PSTN interworking unit 844.

The SIP message handler 843 handles SMS message delivery and call connection/release or handles SIP messages used for providing various additional services. The MSC/PSTN interworking unit 844 controls call connection service to the MSC 860 or an undepicted PSTN. The VLR 845 stores a subscriber profile delivered from the SMSC/HLR interworking unit 841 during location registration for a mobile terminal. The CCF/SSF 846 manages a subscriber's call state by interworking with the MSC/PSTN interworking unit 844 and the SIP message handler 843, and controls various additional services.

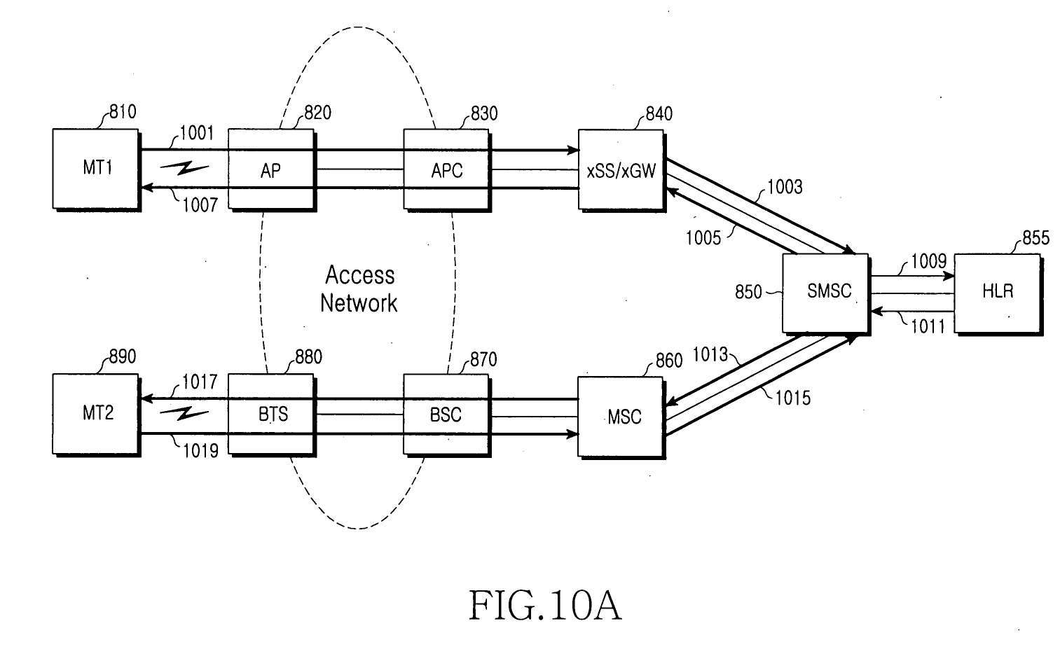

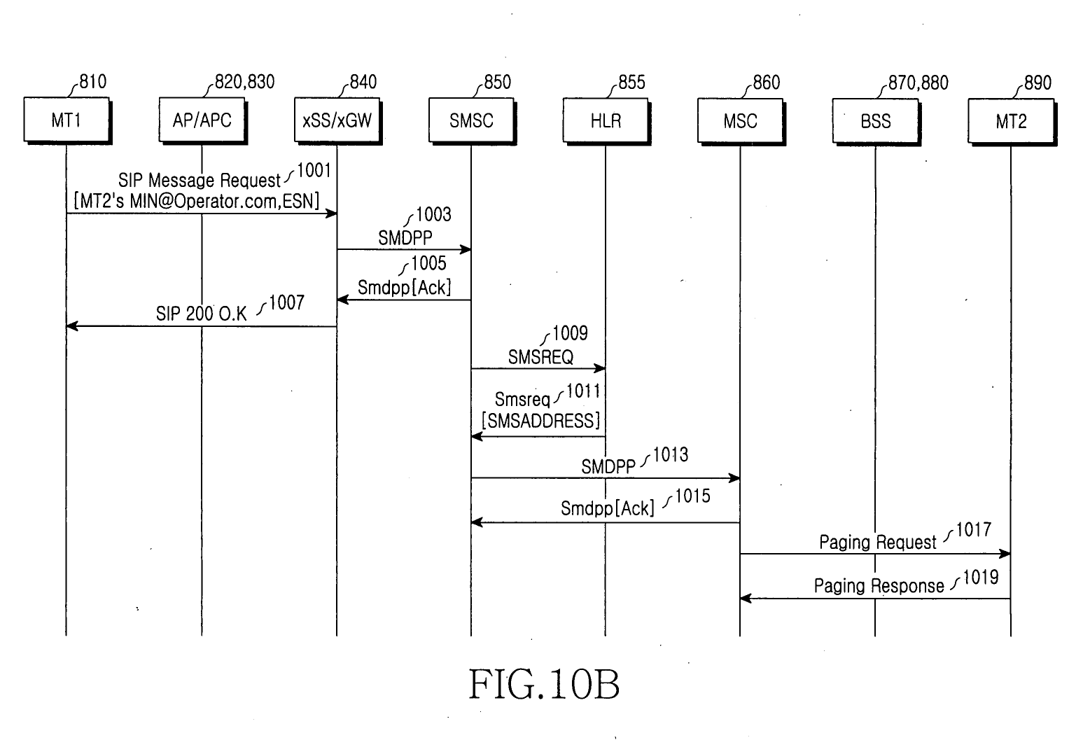

With reference to FIGS. 10 through 12, a detailed description will now be made of an exemplary SMS message transmission/reception operation between a wireless packet network and a mobile communication network, and an exemplary SMS message transmission/reception operation between wireless packet networks, both of the operations being performed through the network interworking system. In the drawings, the same or similar elements are denoted by the same reference numerals even though they are depicted in different drawings. In FIGS. 10 through 12, an access network comprises both a wireless packet network and a mobile communication network, to each of which a mobile terminal is connected.

FIG. 10A is a network configuration diagram illustrating an SMS message transmission process from a wireless packet network to a mobile communication network according to an embodiment of the present invention, and FIG. 10B is a signaling diagram illustrating the SMS message transmission process. In the SMS message transmission process, a first mobile terminal MT1 810 in the wireless packet network transmits a request for transmission of an SMS message to a second mobile terminal MT2 890 in the mobile communication network. In addition, it will be assumed for illustration purposes that an HLR 855 registers therein a subscriber profile including location information of the first and second mobile terminals MT1 810 and MT2 890.

It is assumed for illustration purposes in FIG. 10A that the first mobile terminal MT1 810 is a calling terminal connected to the wireless packet network and the second mobile terminal MT2 890 is a called terminal connected to the mobile communication network. For convenience, in FIG. 10B, a BTS 880 and a BSC 870 are denoted by a BSS.

In step 1001, the first mobile terminal MT1 810, a calling terminal, transmits a SIP Message Request message including an MIN of the second mobile terminal MT2 890, a called terminal, and its own ESN along with an SMS message input by a user to a packet switch 840 via an AP 820 and an APC 830 to request transmission of an SMS message to the second mobile terminal MT2 890. Herein, the MIN is preferably transmitted in a SIP URL form.

Upon receiving the SIP Message Request message, the packet switch 840 transmits in step 1003 an SMDPP message for requesting SMS message transmission to the second mobile terminal MT2 890 along with the corresponding SMS message, to the SMSC 850 using an IS-41 MAP. Upon receiving the SMDPP message, the SMSC 850 transmits in step 1005 an smdpp message indicating the successful receipt to the packet switch 840. Thereafter, in step 1007, the packet switch 840 transmits to the first mobile terminal MT1 810 a SIP O.K message (or 200 O.K message) indicating the successful transmission of the SMS message to the SMSC 850.

Upon receiving the SMDPP message, the SMSC 850 transmits in step 1009 an SMS Request (SMSREQ) message including, for example, MIN information of the second mobile terminal MT2 890 to an HLR 855, so that the HLR 855 can refer to an MSC 860 in which the called terminal is located. In step 1011, the HLR 855 delivers an SMS Response (smsreq[SMSADDRESS]) message including location (address) information of the MSC 860 in which the second mobile terminal MT2 890 is registered, i.e., location information of the second mobile terminal 890, to the SMSC 850. Upon detecting the location information of the second mobile terminal MT2 890, the SMSC 850 transmits in step 1013 an SMDPP message including the SMS message and an MIN of the second mobile terminal MT2 890 to the MSC 860. In step 1015, the MSC 860 transmits an smdpp message indicating the successful receipt to the SMSC 850.

Although the ESN of the calling terminal being delivered to the packet switch 840 in step 1001 is not illustrated in FIG. 10B, it is delivered to the HLR 855 through the SMDPP message in step 1003 and the SMSREQ message in step 1009, and the HLR 855 determines whether the calling terminal is a registered terminal by analyzing the ESN and delivers location information of the called terminal to the SMSC 850 in step 1011 if it is determined that the calling terminal is a registered terminal.

Thereafter, in step 1017, the MSC 860 detects a location of the second mobile terminal MT2 890 corresponding to the MIN by referring to an internal VLR (not shown), and then transmits a Paging Request message for SMS message transmission to the second mobile terminal MT2 890 via a BSS 870 and 880. In step 1019, the second mobile terminal MT2 890 transmits a Paging Response message to the MSC 860 to receive the SMS message from the first mobile terminal MT1 810.

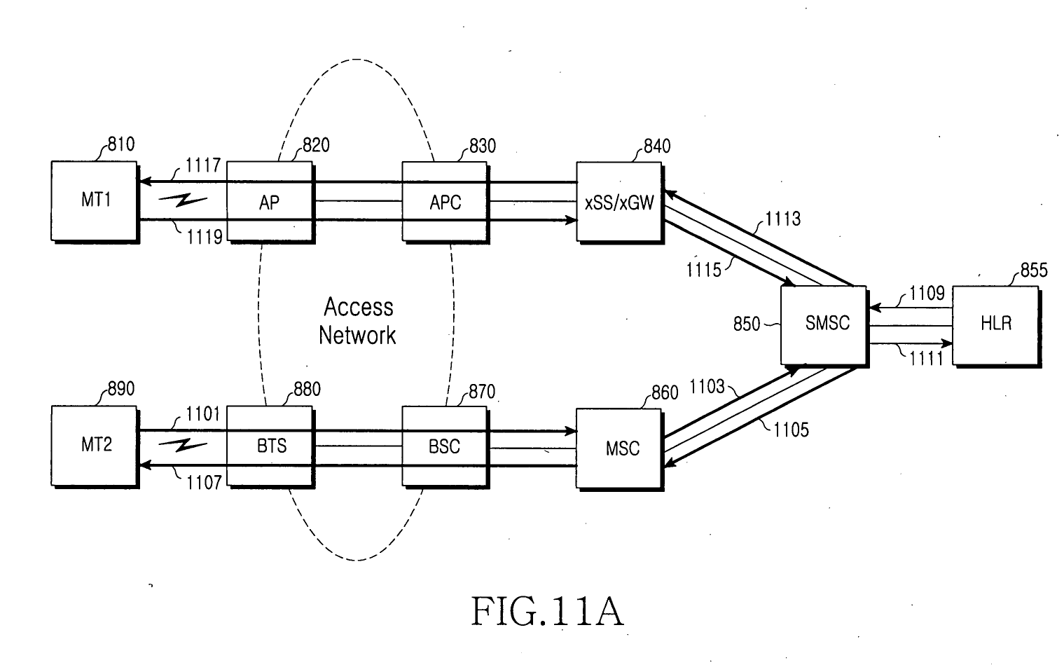

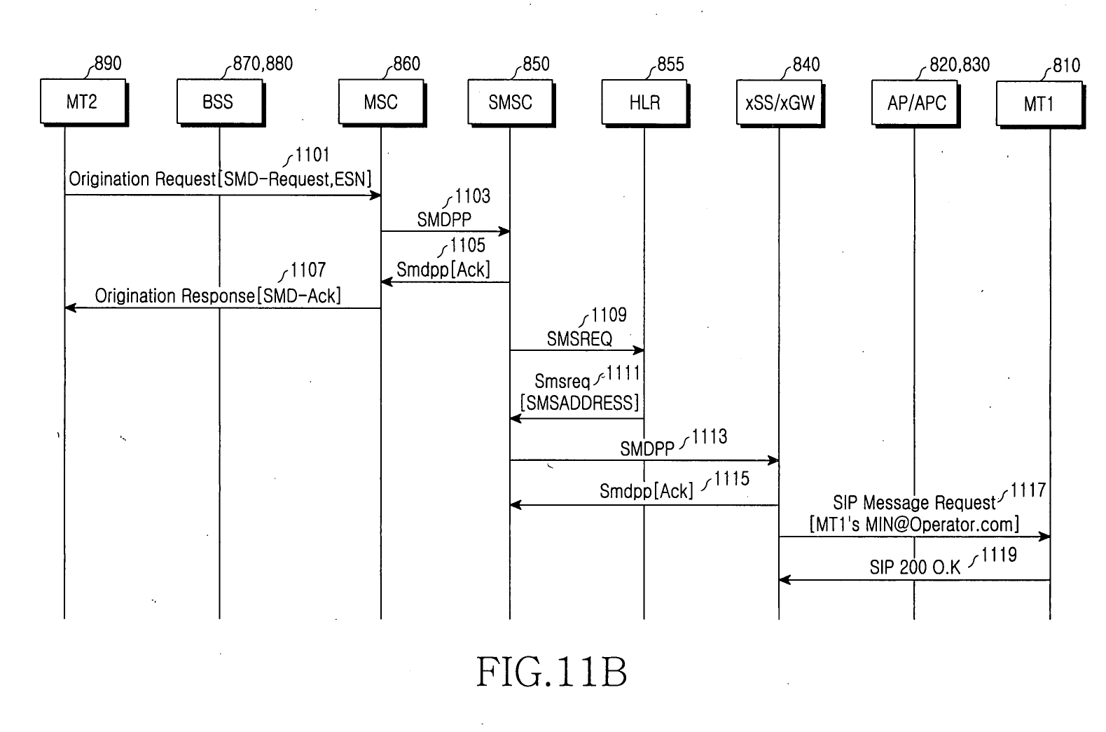

FIG. 11A is a network configuration diagram illustrating an SMS message transmission process from a mobile communication network to a wireless packet network according to another embodiment of the present invention, and FIG. 11B is a signaling diagram illustrating the SMS message transmission process. In the SMS message transmission process, a second mobile terminal MT2 890 in the mobile communication network transmits a request for transmission of an SMS message to a first mobile terminal MT1 810 in the wireless packet network. In addition, it will be assumed for illustration purposes that an HLR 855 registers therein a subscriber profile including location information of the first and second mobile terminals MT1 810 and MT2 890.

It is assumed for illustration purposes in FIG. 11A that the second mobile terminal MT2 890 is a calling terminal connected to the mobile communication network and the first mobile terminal MT1 810 is a called terminal connected to the wireless packet network. For convenience, in FIG. 11B, a BTS 880 and a BSC 870 are denoted by a BSS.

In step 1101, the second mobile terminal MT2 890, a calling terminal, transmits an Origination Request[SMD-Request] message including an MIN of the first mobile terminal MT1 810, a called terminal, and its ESN along with an SMS message input by a user to an MSC 860 via a BSS 870 and 880 to request transmission of an SMS message to the first mobile terminal MT1 810. Upon receiving the Origination Request[SMD-Request] message, the MSC 860 transmits in step 1103 an SMDPP message for requesting SMS message transmission to first mobile terminal MT1 810 along with the corresponding SMS message, to an SMSC 850 using an IS-41 MAP. Upon receiving the SMDPP message, the SMSC 850 transmits an smdpp message indicating the successful receipt to the MSC 860 in step 1105.

Thereafter, in step 1107, the MSC 860 transmits an Origination Response[SMD-Response] message indicating the successful transmission of the SMS message to the SMSC 850, to the second mobile terminal MT2 890. Upon receiving the SMDPP message, the SMSC 850 transmits in step 1109 an SMS Request (SMSREQ) message including, for example, MIN information of the first mobile terminal MT1 810 to an HLR 855, so that the HLR 855 can refer to the packet switch 840 in which the called terminal is registered. In step 1111, the HLR 855 transmits an SMS Response (smsreq[SMSADDRESS]) message including location (address) information of the packet switch 840 in which the first mobile terminal MT1 810 is registered, i.e., location information of the first mobile terminal MT1 810, to the SMSC 850.

Although the ESN of the calling terminal being delivered to the MSC 860 in step 1101 is not illustrated in FIG. 11B, it is delivered to the HLR 855 through the SMDPP message in step 1103 and the SMSREQ message in step 1109, and the HLR 855 determines whether the calling terminal is a registered terminal by analyzing the ESN and delivers location information of the called terminal to the SMSC 850 in step 1111 if it is determined that the calling terminal is a registered terminal.

Upon detecting the location information of the first mobile terminal MT1 810, the SMSC 850 transmits in step 1113 an SMDPP message including the SMS message and an MIN of the first mobile terminal MT1 810 to the packet switch 840. In step 1115, the packet switch 840 transmits an smdpp message indicating the successful receipt to the SMSC 850. Thereafter, in step 1117, the packet switch 840 detects a location of the first mobile terminal MT1 810 corresponding to the MIN by referring to an internal VLR, and then transmits a SIP Message Request message for SMS message transmission to the first mobile terminal MT1 810 via an AP 820 and an APC 830. In step 1119, the first mobile terminal MT1 810 transmits a SIP O.K message (or 200 O.K message) to the packet switch 840 to receive the SMS message from the second mobile terminal MT2 890.

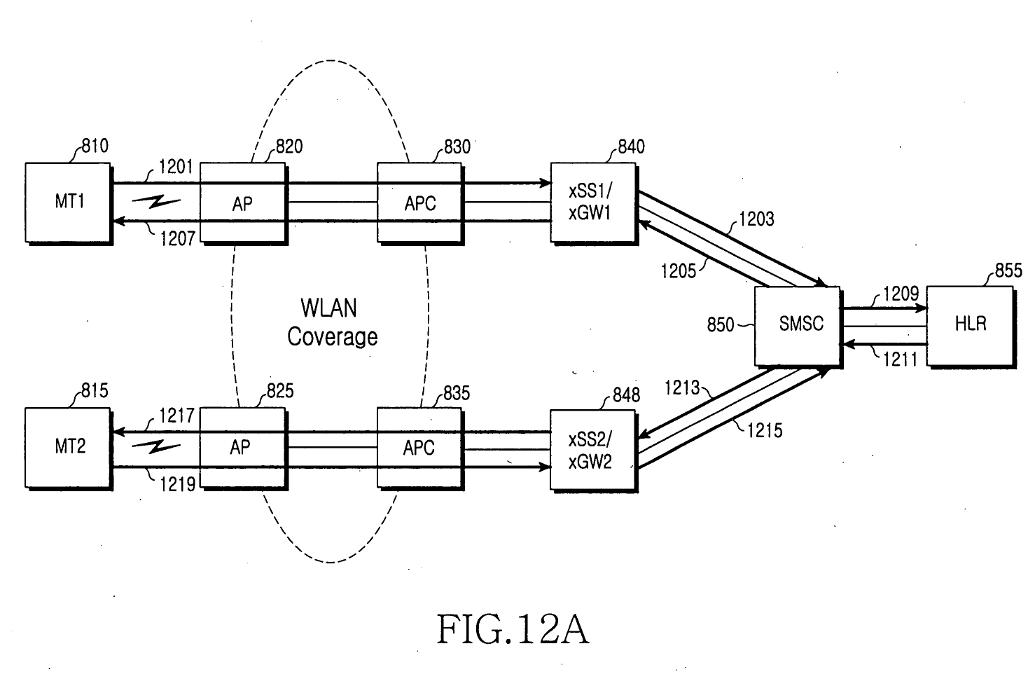

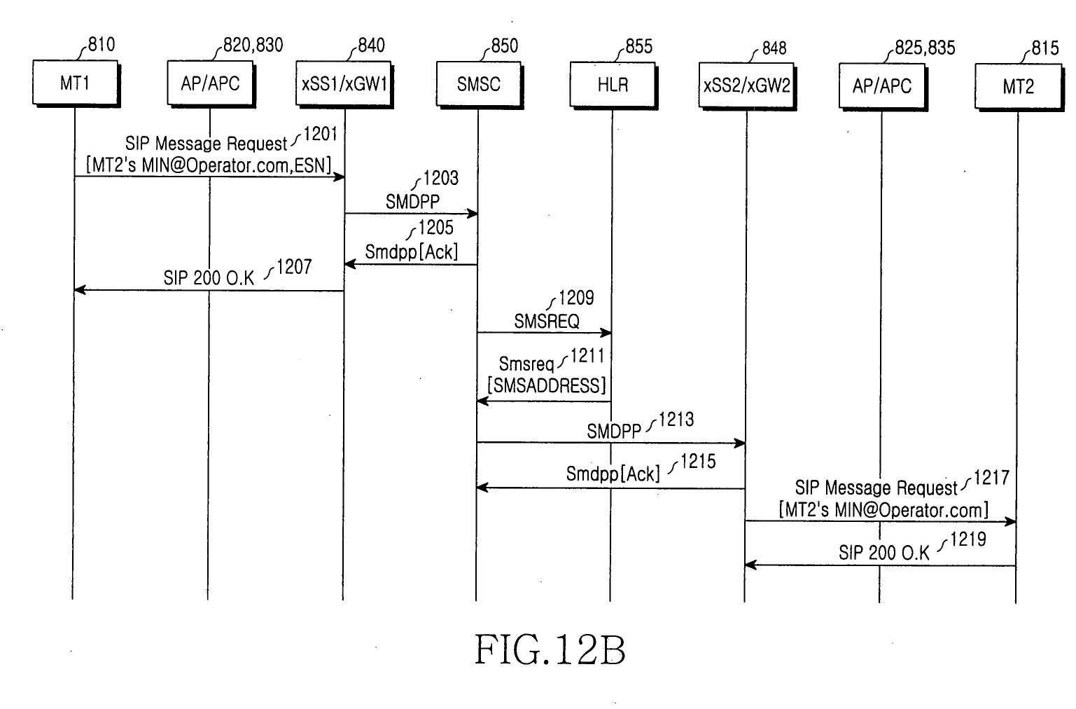

FIG. 12A is a network configuration diagram illustrating an SMS message transmission process between wireless packet networks belonging to different domains according to another embodiment of the present invention, and FIG. 12B is a signaling diagram illustrating the SMS message transmission process. In the SMS message transmission process, a first mobile terminal MT1 810 connected to a first wireless packet network transmits a request for transmission of an SMS message to a second mobile terminal MT2 890 connected to a second wireless packet network. In addition, it will be assumed for illustration purposes that an HLR 855 registers therein a subscriber profile including location information of the first and second mobile terminals MT1 810 and MT2 890.

In FIG. 12A, the first and second wireless packet networks individually provide packet services and include first and second packet switches (xSS1/xGW1) 840 and (xSS2/xGW2) 848 for handling SMS message transmission by interworking with an SMSC 850, respectively, and the first and second packet switches 840 and 848 both have the structure described in connection with FIG. 9.

In step 1201, the first mobile terminal MT1 810, a calling terminal, transmits a SIP Message Request message including an MIN2 of the second mobile terminal MT2 815, a called terminal, and its own ESN along with an SMS message to a first packet switch 840 through an AP 820 and an APC 830 to request transmission of an SMS message to the second mobile terminal MT2 815. Herein, the MIN2 is preferably transmitted in a URL form.

Upon receiving the SIP Message Request message, the first packet switch 840 transmits in step 1203 an SMDPP message for requesting SMS message transmission to the second mobile terminal MT2 815 along with a corresponding SMS message, to the SMSC 850 using an IS-41 MAP. Upon receiving the SMDPP message, the SMSC 850 transmits in step 1205 an smdpp message indicating the successful receipt to the first packet switch 840. In step 1207, the first packet switch 840 transmits a SIP O.K message (or SIP 200 O.K message) indicating the successful transmission to the SMSC 850, to the first mobile terminal MT1 810.

Upon receiving the SMDPP message, the SMSC 850 transmits in step 1209 an SMS Request (SMSREQ) message including, for example, MIN information of the second mobile terminal MT2 815 to an HLR 855, so that the HLR 855 can refer to a second packet switch 848 in which the second mobile terminal MT2 815 is located. In step 1211, the HLR 855 delivers an SMS Response (smsreq [SMSADDRESS] message including location (address) information of the second packet switch 848 in which the second mobile terminal MT2 815 is registered, i.e., location information of the second mobile terminal MT2 815, to the SMSC 850.

Although the ESN of the calling terminal being delivered to the first packet switch 840 in step 1201 is not illustrated in FIG. 12B, it is delivered to the HLR 855 through the SMDPP message in step 1203 and the SMSREQ message in step 1209, and the HLR 855 determines whether the calling terminal is a registered terminal by analyzing the ESN and delivers location information of the called terminal to the SMSC 850 in step 1211 if it is determined that the calling terminal is a registered terminal.

Upon detecting the location information of the second mobile terminal MT2 815, the SMSC 850 transmits in step 1213 an SMDPP message including the SMS message and an MIN of the first mobile terminal MT1 810 to the corresponding second packet switch 848. In step 1215, the second packet switch 848 transmits an smdpp message indicating the successful receipt to the SMSC 850. Thereafter, in step 1217, the second packet switch 848 detects a location of the second mobile terminal MT2 815 corresponding to the MIN by referring to an internal VLR, and then transmits a SIP Message Request message for SMS message transmission to the second mobile terminal MT2 815 via an AP 825 and an APC 835. In step 1219, the second mobile terminal MT2 815 transmits a SIP O.K message (or SIP 200 O.K message) to the second packet switch 848, to receive the SMS message from the first mobile terminal MT1 810.

Although not illustrated in FIG. 12B, if the second mobile terminal MT2 815, a called terminal, is powered Off or if the second mobile terminal MT2 815 is located in a blanket area where it cannot receive SMS messages, the second mobile terminal MT2 815 cannot transmit the SIP O.K message (or SIP 200 O.K message) in step 1219. In this case, it is preferable that after detecting the SMS reception failure of the second mobile terminal MT2 815 through the second packet switch 848, the SMSC 850 periodically repeats transmission of the SMS message until the second mobile terminal MT2 815 successfully receives the SMS message.

As can be understood from the foregoing description, embodiments of the present invention can guarantee seamless voice service between a mobile terminal connected to a mobile communication network and a mobile terminal connected to a wireless packet network, and can easily and effectively perform voice call connection from the mobile communication network to the wireless packet network, or voice call connection from the wireless packet network to the mobile communication network.

In addition, embodiments of the present invention can provide a location registration/deregistration process for a subscriber in a communication system in which the wireless packet network interworks with the mobile communication network. Further, embodiments of the present invention can provide wire/wireless integrated voice and additional services by linking circuit-switched voice service with VoIP-based service.

Moreover, embodiments of the present invention can substantially guarantee SMS service interworking between a mobile terminal connected to a mobile communication network and a mobile terminal connected to a wireless packet network, and can easily and effectively perform SMS message transmission from the mobile communication network to the wireless packet network, or SMS message transmission from the wireless packet network to the mobile communication network.

Further, embodiments of the present invention can provide the SMS service used in the mobile communication network even between wireless packet networks, and provide retransmission service unlike the general packet service, when a called terminal cannot receive signals.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A network interworking system for connecting a voice call from a calling terminal in a wireless packet network that provides voice over Internet protocol (VoIP) service to a called terminal in a mobile communication network that provides circuit-switched voice service, the system comprising:
a home location register (HLR) for registering therein location information of terminals and a subscriber profile;
a packet switch for transmitting a call connection request to a location of the called terminal, wherein the called terminal is detected through the HLR, upon receiving an origination message including a terminal identifier of the called terminal;
an access network for receiving the origination message from the calling terminal in the wireless packet network and delivering the received origination message to the packet switch;
a mobile switching center (MSC) for transmitting a paging message for voice call connection to the called terminal upon receiving a call connection request for the called terminal from the packet switch; and
a base station system (BSS) for transmitting a paging message from the MSC in the mobile communication network to the called terminal.

2. The network interworking system of claim 1, wherein:
the terminal identifier comprises a mobile identification number (MIN); and
the origination message comprises a session initiation protocol (SIP) invite request message generated by representing the terminal identifier in the form of a SIP uniform resource locator (URL).

3. The network interworking system of claim 1, wherein the origination message further comprises:
an electronic serial number (ESN) of the calling terminal, and the HLR is configured to determine whether the calling terminal is a registered terminal by analyzing the ESN included in the origination message and provide location information of the called terminal to the packet switch if the calling terminal is a registered terminal.

4. The network interworking system of claim 1, wherein the HLR is configured to deliver location information of the called terminal to the packet switch using an interim standard-41 mobile application part (IS-41 MAP) message.

5. The network interworking system of claim 1, wherein the calling terminal and the called terminal comprise dual-mode terminals, each of which is configured to access both the mobile communication network and the wireless packet network.

6. The wireless interworking system of claim 1, wherein the wireless packet network is located in an area of the mobile communication network.

7. The wireless interworking system of claim 2, wherein the packet switch is configured to:
transmit an initial address message (IAM) message including call setup information for call connection between the calling terminal and the called terminal to the MSC in the mobile communication network when the SIP invite request message is received from the wireless packet network and a location of the called terminal is detected from the SIP invite request message.

8. A network interworking system for connecting a voice call from a calling terminal in a mobile communication network that provides circuit-switched voice service to a called terminal in a wireless packet network that provides voice over Internet protocol (VoIP) service, the system comprising:
a home location register (HLR) for registering therein location information of terminals and a subscriber profile;
a mobile switching center (MSC) for transmitting a call connection request to a location of the called terminal, wherein the called terminal is detected through the HLR, upon receiving an origination message including a terminal identifier of the called terminal;
a base station system (BSS) for receiving the origination message from the calling terminal in the mobile communication network and delivering the origination message to the MSC;
a packet switch for transmitting a request message for voice call connection to the called terminal upon receiving a call connection request for the called terminal from the MSC; and
an access network for receiving the request message from the packet switch in the wireless packet network and delivering the request message to the called terminal.

9. The network interworking system of claim 8, wherein the terminal identifier comprises a mobile identification number (MIN).

10. The network interworking system of claim 8, wherein the origination message further comprises:
an electronic serial number (ESN) of the calling terminal, and the HLR is configured to determine whether the calling terminal is a registered terminal by analyzing the ESN included in the origination message and provide location information of the called terminal to the MSC if the calling terminal is a registered terminal.

11. The network interworking system of claim 8, wherein the HLR is configured to deliver location information of the called terminal to the MSC using an interim standard-41 mobile application part (IS-41 MAP) message.

12. The network interworking system of claim 8, wherein the calling terminal and the called terminal comprise dual-mode terminals, each of which is configured to access both the mobile communication network and the wireless packet network.

13. The network interworking system of claim 8, wherein the wireless packet network is located in an area of the mobile communication network.

14. The wireless interworking system of claim 8, wherein the packet switch comprises:
a session initiation protocol (SIP) message handling means for handling a SIP message; and
a network interworking means for transmitting a SIP invite request message indicating arrival of a voice call to the called terminal through the SIP message handling means upon receiving an initial address message (IAM) message including call setup information for call connection between the calling terminal and the called terminal from the MSC.

15. A network interworking method for connecting a voice call from a calling terminal in a wireless packet network that provides voice over Internet protocol (VoIP) service to a called terminal in a mobile communication network that provides circuit-switched voice service, the method comprising the steps of:
registering location information of terminals and a subscriber profile in a home location register (HLR);
transmitting an origination message including a terminal identifier of the called terminal to a packet switch in the wireless packet network;
transmitting, by the packet switch, a call connection request to a location of the called terminal, wherein the called terminal is detected through the HLR based on the terminal identifier, upon receiving the origination message; and
upon receiving the call connection request for the called terminal, transmitting a paging message for voice call connection to the called terminal by a mobile switching center (MSC) in the mobile communication network.

16. The network interworking method of claim 15, wherein:
the terminal identifier comprises a mobile identification number (MIN); and
the origination message comprises a session initiation protocol (SIP) invite request message generated by representing the terminal identifier in the form of a SIP uniform resource locator (URL).

17. The network interworking method of claim 15, wherein the origination message further comprises an electronic serial number (ESN) of the calling terminal, and the step of transmitting a call connection request comprises the steps of:
determining by the HLR whether the calling terminal is a registered terminal by analyzing the ESN included in the origination message; and
providing location information of the called terminal to the packet switch if the calling terminal is a registered terminal.

18. The network interworking method of claim 16, wherein the step of transmitting a call connection request comprises the step of:
delivering, by the HLR, location information of the called terminal to the packet switch using an interim standard-41 mobile application part (IS-41 MAP) message.

19. The network interworking method of claim 16, wherein the calling terminal and the called terminal comprise dual-mode terminals, each of which is configured to access both the mobile communication network and the wireless packet network.

20. The wireless interworking method of claim 16, wherein the wireless packet network is located in an area of the mobile communication network.

21. The wireless interworking method of claim 16, wherein the step of transmitting a call connection request comprises the steps of:
receiving, by the packet switch, a SIP invite request message as the origination message, and transmitting a MAP location request message including the terminal identifier to the HLR; and
if a location of the called terminal is detected, transmitting, by the packet switch, initial address message (IAM) message including call setup information for call connection between the calling terminal and the called terminal to the MSC.

22. A network interworking method for connecting a voice call from a calling terminal in a mobile communication network that provides circuit-switched voice service to a called terminal in a wireless packet network that provides voice over Internet protocol (VoIP) service, the method comprising the steps of:
registering location information of terminals and a subscriber profile in a home location register (HLR);
transmitting an origination message including a terminal identifier of the called terminal to a mobile switching center (MSC) in the mobile communication network;
transmitting a call connection request to a location of the called terminal, wherein the called terminal is detected through the HLR based on the terminal identifier; and
upon receiving the call connection request for the called terminal, transmitting a request message for voice call connection to the called terminal by the packet switch in the wireless packet network.

23. The network interworking method of claim 22, wherein the terminal identifier comprises a mobile identification number (MIN).

24. The network interworking method of claim 22, wherein the origination message further comprises an electronic serial number (ESN) of the calling terminal, and the step of transmitting a call connection request comprises the steps of:
determining by the HLR whether the calling terminal is a registered terminal by analyzing the ESN included in the origination message; and
providing location information of the called terminal to the MSC if the calling terminal is a registered terminal.

25. The network interworking method of claim 22, wherein the step of transmitting a call connection request comprises the step of:
delivering, by the HLR, location information of the called terminal to the MSC using an interim standard-41 mobile application part (IS-41 MAP) message.

26. The network interworking method of claim 22, wherein the calling terminal and the called terminal comprise dual-mode terminals, each of which is configured to access both the mobile communication network and the wireless packet network.

27. The network interworking method of claim 22, wherein the wireless packet network is located in an area of the mobile communication network.

28. The wireless interworking method of claim 22, wherein the step of transmitting a request message comprises the steps of:
receiving, by the packet switch, an initial address message (IAM) message including call setup information for voice call connection between the calling terminal and the called terminal from the MSC; and
transmitting, by the packet switch, a session initiation protocol (SIP) invite request message indicating arrival of the voice call to the called terminal.

29. A network interworking system for connecting a voice call from a calling terminal in a first wireless packet network that provides voice over Internet protocol (VoIP) service to a called terminal in a second wireless packet network that provides circuit-switched voice service, the system comprising:
a home location register (HLR) for registering therein location information of terminals and a subscriber profile;
a first packet switch in the first wireless packet network for transmitting a call connection request to a location of the called terminal, wherein the called terminal is detected through the HLR, upon receiving an origination message including a terminal identifier of the called terminal;
a first access network for receiving the origination message from the calling terminal and delivering the received origination message to the first packet switch;
a second packet switch in the second wireless packet network for transmitting a request message for voice call connection to the called terminal upon receiving a call connection request for the called terminal from the first packet switch; and
a second access network for transmitting the request message from the second packet switch to the called terminal.

30. A network interworking method for connecting a voice call from a calling terminal in a first wireless packet network that provides voice over Internet protocol (VoIP) service to a called terminal in a second wireless packet network that provides circuit-switched voice service, the method comprising the steps of:
registering location information of terminals and a subscriber profile in a home location register (HLR);
transmitting an origination message including a terminal identifier of the called terminal to a first packet switch in the first wireless packet network;
transmitting, by the first packet switch, a call connection request to a location of the called terminal, wherein the called terminal is detected through the HLR based on the terminal identifier, upon receiving the origination message; and
upon receiving the call connection request for the called terminal, transmitting a request message for voice call connection to the called terminal by a second packet switch in the second wireless packet network.

31. A packet switch apparatus included in a network interworking system for connecting a voice call between a first mobile terminal in a wireless packet network that provides voice over Internet protocol (VoIP) service and a second mobile terminal in a mobile communication network that provides circuit-switched voice service, the apparatus comprising:
a softswitch system comprising a session initiation protocol (SIP) message handler for performing location registration on the first mobile terminal through a home location register (HLR) shared with a mobile switching center (MSC) in the mobile communication network and transmitting/receiving a SIP-based message for voice call connection between the first and second mobile terminals, and an MSC interworking unit for exchanging a message including call setup information between the first and second mobile terminals with the MSC; and
a gateway connected to the softswitch system through a predetermined control protocol for performing data conversion between the wireless packet network and the mobile communication network.

32. The packet switch apparatus of claim 31, wherein the softswitch system further comprises:
an HLR interworking unit for receiving a SIP registration request message including a mobile identification number (MIN) and an electronic serial number (ESN) from the first mobile terminal during location registration for the mobile terminal, delivering the SIP registration request message to the HLR, receiving a corresponding subscriber profile from the HLR in response thereto, and registering a location of a corresponding subscriber in a visitor location register (VLR).

33. The packet switch apparatus of claim 31, wherein:
when connecting a voice call from the first mobile terminal to the second mobile terminal, the MSC interworking unit is configured to transmit an initial address message (IAM) message including call setup information to the MSC if receipt of an origination message of the first mobile terminal is detected by the SIP message handler and a location of the second mobile terminal is detected by the HLR.

34. The packet switch apparatus of claim 33, wherein the origination message comprises a SIP invite request message including an ESN of the first mobile terminal and a MIN of the second mobile terminal.

35. The packet switch apparatus of claim 31, wherein:
when connecting a voice call from the second mobile terminal to the first mobile terminal, the MSC interworking unit is configured to transmit a SIP invite request message indicating arrival of a voice call to the first mobile terminal through the SIP message handler if an IAM message including call setup information is received from the MSC.

36. A location registration method for a mobile terminal in a network interworking system including a packet switch, the method comprising the steps of:
transmitting, by the mobile terminal, a session initiation protocol (SIP) registration request message including its own terminal identifier and electronic serial number (ESN) to the packet switch;
transmitting, by the packet switch, a location registration request message including the terminal identifier and the ESN to a home location register (HLR) shared by a mobile communication network and a wireless packet network;
determining, by the HLR, whether the mobile terminal is a registered terminal by analyzing the terminal identifier and the ESN and transmitting a location registration response message including the corresponding subscriber profile to the packet switch if the mobile terminal is a registered terminal; and
registering, by the packet switch, a location of the mobile terminal in a visitor location register (VLR) based on the subscriber profile.

37. The location registration method of claim 36, further comprising the steps of:
during location deregistration for the mobile terminal, transmitting, by the mobile terminal, a SIP registration request message with a lifetime field being set to ‘0’ to the packet switch, the lifetime field indicating a location registration period;
transmitting, by the packet switch, a location registration deregistration request message to the HLR and receiving a response message from the HLR; and
deregistering, by the packet switch, the location of the mobile terminal based on the subscriber profile.

38. A network interworking system for providing short message service (SMS) service from a calling terminal in a wireless packet network to a called terminal in a circuit-switched mobile communication network, the system comprising:
a home location register (HLR) for registering therein location information of terminals and a subscriber profile;
a packet switch for, if an SMS message and an origination message including a terminal identifier of the called terminal are received from the calling terminal, transmitting a first delivery message including the SMS message and the terminal identifier;
an SMS center (SMSC) for, upon receiving the first delivery message, transmitting a second delivery message including the SMS message and the terminal identifier to a location of the called terminal, wherein the called terminal is detected through the HLR; and
a mobile switching center (MSC) for, upon receiving the second delivery message, transmitting a paging message indicating arrival of the SMS message to the called terminal.

39. The network interworking system of claim 38, wherein the origination message further comprises:
an electronic serial number (ESN) of the calling terminal, and the HLR is configured to determine whether the calling terminal is a registered terminal by analyzing the ESN included in the origination message and provide location information of the called terminal to the SMSC if the calling terminal is a registered terminal.

40. The network interworking system of claim 38, wherein:
if a session initiation protocol (SIP) invite request message generated by representing the terminal identifier in the form of a SIP uniform resource locator (URL) is received as the origination message, the packet switch is configured to transmit an interim standard-41 mobile application part (IS-41 MAP)-based SMS delivery point to point (SMDPP) message as the first delivery message.

41. A network interworking system for providing short message service (SMS) service from a calling terminal in a circuit-switched mobile communication network to a called terminal in a wireless packet network, the system comprising:
a home location register (HLR) for registering therein location information of terminals and a subscriber profile;
a mobile switching center (MSC) for, if an SMS message and an origination message including a terminal identifier of the called terminal are received from the calling terminal, transmitting a first delivery message including the SMS message and the terminal identifier;
an SMS center (SMSC) for, upon receiving the first delivery message, transmitting a second delivery message including the SMS message and the terminal identifier to a location of the called terminal, wherein the called terminal is detected through the HLR; and
a packet switch for, upon receiving the second delivery message, transmitting a request message indicating arrival of the SMS message to the called terminal.

42. The network interworking system of claim 41, wherein the origination message further comprises:
an electronic serial number (ESN) of the calling terminal, and the HLR is configured to determine whether the calling terminal is a registered terminal by analyzing the ESN included in the origination message and provide location information of the called terminal to the SMSC if the calling terminal is a registered terminal.

43. The network interworking system of claim 41, wherein the packet switch comprises:
a session initiation protocol (SIP) message handling means for handling a SIP message; and
a network interworking means for transmitting a SIP invite request message as the request message through the SIP message handing means upon receiving an interim standard-41 mobile application part (IS-41 MAP)-based SMS delivery point to point (SMDPP) message as the second delivery message.

44. A network interworking system for providing short message service (SMS) service from a calling terminal in a first wireless packet network to a called terminal in a second wireless packet network, the system comprising:
a home location register (HLR) for registering therein location information of terminals and a subscriber profile;
a first packet switch for, if an SMS message and an origination message including a terminal identifier of the called terminal are received from the calling terminal, transmitting a first delivery message including the SMS message and the terminal identifier;
an SMS center (SMSC) for, upon receiving the first delivery message, transmitting a second delivery message including the SMS message and the terminal identifier to a location of the called terminal, wherein the called terminal is detected through the HLR; and
a second packet switch for, upon receiving the second delivery message from the SMSC, transmitting a request message indicating arrival of the SMS message to the called terminal.

45. The network interworking system of claim 44, wherein the origination message further comprises:
an electronic serial number (ESN) of the calling terminal, and the HLR is configured to determine whether the calling terminal is a registered terminal by analyzing the ESN included in the origination message and provide location information of the called terminal to the SMSC if the calling terminal is a registered terminal.

46. A network interworking method for providing short message service (SMS) service from a calling terminal in a wireless packet network to a called terminal in a circuit-switched mobile communication network, the method comprising the steps of:
registering location information of terminals and a subscriber profile in a home location register (HLR);
transmitting an origination message including an SMS message of the calling terminal and a terminal identifier of the called terminal to a packet switch in the wireless packet network;
transmitting, by the packet switch, a first delivery message including the SMS message and the terminal identifier to an SMS center (SMSC) upon receiving the origination message;
transmitting, by the SMSC, a second delivery message including the SMS message and the terminal identifier to a location of the called terminal, wherein the called terminal is detected through the HLR based on the terminal identifier, upon receiving the first delivery message; and
transmitting, by the MSC, a paging message indicating arrival of the SMS message to the called terminal upon receiving the second delivery message.

47. A network interworking method for providing short message service (SMS) service from a calling terminal in a circuit-switched mobile communication network to a called terminal in a wireless packet network, the method comprising the steps of:
registering location information of terminals and a subscriber profile in a home location register (HLR);
transmitting an origination message including an SMS message of the calling terminal and a terminal identifier of the called terminal to a mobile switching center (MSC) in the mobile communication network;
transmitting, by the MSC, a first delivery message including the SMS message and the terminal identifier to an SMS center (SMSC) upon receiving the origination message;
transmitting, by the SMSC, a second delivery message including the SMS message and the terminal identifier to a location of the called terminal, wherein the called terminal is detected through the HLR based on the terminal identifier, upon receiving the first delivery message; and
transmitting, by a packet switch, a request message indicating arrival of the SMS message to the called terminal upon receiving the second delivery message.

48. A network interworking method for providing short message service (SMS) service from a calling terminal in a first wireless packet network to a called terminal in a second wireless packet network, the method comprising the steps of:
registering location information of terminals and a subscriber profile in a home location register (HLR);
transmitting an origination message including an SMS message of the calling terminal and a terminal identifier of the called terminal to a first packet switch in the first wireless packet network;
transmitting, by the first packet switch, a first delivery message including the SMS message and the terminal identifier to an SMS center (SMSC) upon receiving the origination message;
transmitting, by the SMSC, a second delivery message including the SMS message and the terminal identifier to a location of the called terminal, wherein the called terminal is detected through the HLR, upon receiving the first delivery message; and
transmitting, by a second packet switch in the second wireless packet network, a request message indicating arrival of the SMS message to the called terminal upon receiving the second delivery message.

49. A packet switch apparatus included in a network interworking system for providing short message service (SMS) service between a first mobile terminal in a wireless packet network and a second mobile terminal in a circuit-switched mobile communication network, the apparatus comprising:
a softswitch system comprising a session initiation protocol (SIP) message handler for performing location registration on the first mobile terminal through a home location register (HLR) shared with a mobile switching center (MSC) in the mobile communication network and transmitting/receiving a SIP-based message for SMS message delivery between the first and second mobile terminals, and an SMS center (SMSC) interworking unit for exchanging a delivery message including an SMS message and a terminal identifier of the called terminal with the SMSC; and
a gateway connected to the softswitch system through a predetermined control protocol for performing data conversion between the wireless packet network and the mobile communication network.

50. The packet switch apparatus of claim 49, wherein the delivery message comprises an interim standard-41 mobile application part (IS-41 MAP)-based SMS delivery point to point (SMDPP) message.
